(19) United States
(12) Patent Application Publication
(10) Pub. No.: US 2016/0132929 A1
(43) Pub. Date: May 12, 2016

(54) ADVERTISEMENT SYSTEM, AND ADVERTISEMENT PROCESSING DEVICE

(71) Applicant: RAKUTEN, INC., Setagaya-ku, Tokyo (JP)

(72) Inventors: Udana BANDARA, Setagaya-ku, Tokyo (JP); Alex CHIA, Setagaya-ku, Tokyo (JP); James CHEN, Setagaya-ku, Tokyo (JP)

(21) Appl. No.: 14/901,066

(22) PCT Filed: Jun. 28, 2013
(86) PCT No.: PCT/JP2013/067935

§ 371 Date: Dec. 28, 2015

(51) Int. Cl. G06Q 30/02

(52) U.S. Cl. CPC G06Q 30/0261; G06Q 30/0267

(57) ABSTRACT

A candidate region setting unit sets a candidate region, which is a candidate for a target region in real space to be associated with an electronic advertisement, based on position information that indicates the position of a user terminal and that is obtained by the user terminal. A target region setting unit sets a partial region of the candidate region as the target region to be associated with the electronic advertisement. An association information registering unit registers, in an association information storage unit, association information that indicates an association between the electronic advertisement and the region set by the target region setting unit.

### TECHNICAL FIELD

The present invention relates to an advertisement system, an advertisement system control method, an advertisement processing device, an advertisement processing device control method, and a program.

### BACKGROUND ART

There have been known systems that provide electronic advertisements. Patent Literature 1, for example, relates to a system that provides electronic coupons, and discloses a technology of transmitting, to a portable terminal, electronic coupons of shops that are located within a given distance from the current position of the portable terminal.

### CITATION LIST

### Patent Literature

[Patent Literature 1] JP 2011-197881 A

### SUMMARY OF INVENTION

### Technical Problem

In real world, an advertisement (e.g., coupons or fliers) is distributed in places farther than a given distance from the location of a shop. For instance, if there is a place that is suitable for advertisement distribution, such as a place where traffic of men is heavy, an advertisement may be distributed in that place even when it is farther than a given distance from a shop's location. As for electronic advertisements (e.g., electronic coupons and electronic fliers), there are cases where providing an electronic advertisement in a place farther than a given distance from the shop's location is desired.

The inventors of the present invention have therefore devised a system in which an electronic advertisement is associated in advance with a real world region designated by a registrant, to provide an electronic advertisement to a user based on the region associated with the electronic advertisement and on the position of the user.

A possible way to attain such a system is employing a configuration that allows a registrant to designate a region on a map displayed on a display unit and that associates the region designated by the registrant with an electronic advertisement.

However, if it is configured that any region on the map can be designated without limitations, a huge number of electronic advertisements may be registered indiscriminatingly. Further, if it is set possible to associate an electronic advertisement with a place without actually visiting and seeing that place, there is also a fear that the electronic advertisement is associated with a place unsuitable for providing an electronic advertisement, such as places where passersby are unlikely to see the advertisement.

To restrain occurrences of such inconveniences, one possible way is to configure the system so that an electronic advertisement cannot be associated with a place unless a registrant actually visits the place.

However, in this case, a registrant has to actually visit a place in question, which bothers him. For instance, even when it is desired to associate an electronic advertisement with a place across a large intersection, a registrant is required to actually cross the intersection and go to the other side.

The present invention has been made in view of the problems described above, and an object of the present invention is therefore to provide an advertisement system, an advertisement system control method, an advertisement processing device, an advertisement processing device control method, and a program capable of preventing indiscriminate registration of a huge number of electronic advertisements and guaranteeing the convenience of registrants at the same time.

### Solution to Problem

In order to solve the problem described above, an advertisement system according to the present invention includes: first position information obtaining means for obtaining first position information about a position of a first user; candidate region setting means for setting, in a case where a request to associate an electronic advertisement with a region in real space is received from the first user, a candidate region based on the first position information, the candidate region being a candidate for a target region to be associated with the electronic advertisement; target region setting means for setting a partial region of the candidate region as the target region to be associated with the electronic advertisement; association information registering means for registering association information in association information storage means, association information indicating an association between the electronic advertisement and a region set by the target region setting means; second position information obtaining means for obtaining second position information about a position of a second user; and electronic advertisement providing means for extracting, in a case where a request to provide an electronic advertisement is received from the second user, an electronic advertisement to be provided to the second user from among electronic advertisements registered in the association information storage means, based on regions registered in the association information storage means and on the second position information, and for providing the extracted electronic advertisement to the second user.

Further, an advertisement system control method according to the present invention includes: a first position information obtaining step of obtaining first position information about a position of a first user; a candidate region setting step of setting, in a case where a request to associate an electronic advertisement with a region in real space is received from the first user, a candidate region based on the first position information, the candidate region being a candidate for a target region to be associated with the electronic advertisement; a target region setting step of setting a partial region of the candidate region as the target region to be associated with the electronic advertisement; an association information registering step of registering association information in association information storage means, the association information indicating an association between the electronic advertisement and the region set in the target region setting step; a second position information obtaining step of obtaining second position information about a position of a second user; and an electronic advertisement providing step of extracting, in a case where a request to provide an electronic advertisement is received from the second user, an electronic advertisement to be provided to the second user from among electronic advertisements registered in the association information storage means, based on regions registered in the association information storage means and on the second position information, and of providing the extracted electronic advertisement to the second user.

Further, an advertisement processing device according to the present invention includes: position information obtaining means for obtaining position information about a position of a user; candidate region setting means for setting, in a case where a request to associate an electronic advertisement with a region in real space is received from the user, a candidate region based on the position information, the candidate region being a candidate for a target region to be associated with the electronic advertisement; target region setting means for setting a partial region of the candidate region as the target region to be associated with the electronic advertisement; and association information registering means for registering, in association information storage means, association information that indicates an association between the electronic advertisement and the region set by the target region setting means.

Further, an advertisement processing device control method according to the present invention includes: a position information obtaining step of obtaining position information about a position of a user; a candidate region setting step of setting, in a case where a request to associate an electronic advertisement with a region in real space is received from the user, a candidate region based on the position information, the candidate region being a candidate for a target region to be associated with the electronic advertisement; a target region setting step of setting a partial region of the candidate region as the target region to be associated with the electronic advertisement; and an association information registering step of registering association information in association information storage means, the association information indicating an association between the electronic advertisement and the region set in the target region setting step.

Further, a program according to the present invention causes a computer to function as: position information obtaining means for obtaining position information about a position of a user; candidate region setting means for setting, in a case where a request to associate an electronic advertisement with a region in real space is received from the user, a candidate region based on the position information, the candidate region being a candidate for a target region to be associated with the electronic advertisement; target region setting means for setting a partial region of the candidate region as the target region to be associated with the electronic advertisement; and association information registering means for registering association information in association information storage means, the association information indicating an association between the electronic advertisement and the region set by the target region setting means.

Further, an information recording medium according to the present invention is a computer-readable information recording medium having the above-mentioned program recorded thereon.

Further, in one aspect of the present invention, the candidate region setting means may set a region that includes a plurality of partial regions, as the candidate region, based on the first position information, and the target region setting means may set at least one of the plurality of partial regions as the target region to be associated with the electronic advertisement.

Further, in one aspect of the present invention, the target region setting means may include: means for presenting the plurality of partial regions to the first user; means for receiving designation of at least one of the plurality of partial regions from the first user; and means for setting, as the target region to be associated with the electronic advertisement, at least one partial region designated by the first user.

Further, in one aspect of the present invention, the plurality of partial regions may include a first partial region including a position indicated by the first position information and a plurality of second partial regions located around the first partial region.

Further, in one aspect of the present invention, the target region setting means may include: means for presenting the candidate region to the first user; means for receiving designation of a position or a partial region inside the candidate region from the first user; and means for setting the target region to be associated with the electronic advertisement, based on the position or the partial region designated by the first user.

Further, in one aspect of the present invention, the candidate region setting means may include: means for setting the candidate region based on the first position information; means for excluding, in a case where the candidate region includes a region to which an electronic advertisement having a given relationship with the electronic advertisement in question is already associated, the region from the candidate region; and means for setting a region outside the candidate region as a substitute region for the region excluded from the candidate region, and for adding the substitute region to the candidate region.

Further, in one aspect of the present invention, the candidate region setting means may include means for setting, as the substitute region, a region through which the first user has passed from among regions that are outside the candidate region.

Further, in one aspect of the present invention, the candidate region setting means may include means for setting, as the substitute region, a region that includes a particular road from among regions that are outside the candidate region.

Further, in one aspect of the present invention, the candidate region setting means may include means for setting, as the substitute region, a region that includes a particular facility from among regions that are outside the candidate region.

Further, in one aspect of the present invention, the candidate region setting means may include means for setting, as the substitute region, a region outside the candidate region based on a volume of traffic of passerby.

Further, in one aspect of the present invention, the candidate region setting means may set the candidate region based on the first position information in a region that is within a reference distance from a location of a shop run by an advertiser of the electronic advertisement.

### Advantageous Effects of Invention

According to the present invention, indiscriminate registration of a huge number of electronic advertisements can be prevented and the convenience of registrants can be guaranteed at the same time.

### BRIEF DESCRIPTION OF DRAWINGS

FIG. 1 is a diagram for illustrating an example of the overall configuration of an advertisement system according to an embodiment of the present invention.

FIG. 2 is a diagram for illustrating the outline of a function of the advertisement system.

FIG. 3 is a diagram for illustrating the outline of the function of the advertisement system.

FIG. 4 is a diagram for illustrating an example of a menu screen.

FIG. 5 is a diagram for illustrating an example of a coupon list screen.

FIG. 6 is a diagram for illustrating an example of a coupon screen.

FIG. 7 is a diagram for illustrating an example of a section designating screen.

FIG. 8 is a diagram for illustrating a candidate region.

FIG. 9 is a diagram for illustrating another example of the section designating screen.

FIG. 10 is a diagram for illustrating an example of a coupon list screen.

FIG. 11 is a diagram for illustrating an example of a coupon screen.

FIG. 12 is a function block diagram of the advertisement system.

FIG. 13 is a diagram for showing an example of a user table.

FIG. 14 is a diagram for showing an example of a user position table.

FIG. 15 is a diagram for showing an example of an advertiser table.

FIG. 16 is a diagram for showing an example of an electronic coupon table.

FIG. 17 is a diagram for showing an example of a possession status table.

FIG. 18 is a diagram for showing an example of a section table.

FIG. 19 is a diagram for showing an example of a registration status table.

FIG. 20 is a diagram for illustrating an example of processing that is executed in the advertisement system.

FIG. 21 is a diagram for illustrating the example of processing that is executed in the advertisement system.

FIG. 22 is a diagram for illustrating another example of processing that is executed in the advertisement system.

FIG. 23 is a diagram for illustrating still another example of processing that is executed in the advertisement system.

FIG. 24 is a diagram for illustrating another example of the section designating screen.

FIG. 25 is a diagram for showing another example of the user position table.

FIG. 26 is a diagram for illustrating another example of the section designating screen.

FIG. 27 is a diagram for illustrating another example of the section designating screen.

### DESCRIPTION OF EMBODIMENTS

Embodiments of the present invention are described below in detail with reference to the drawings.

### First Embodiment

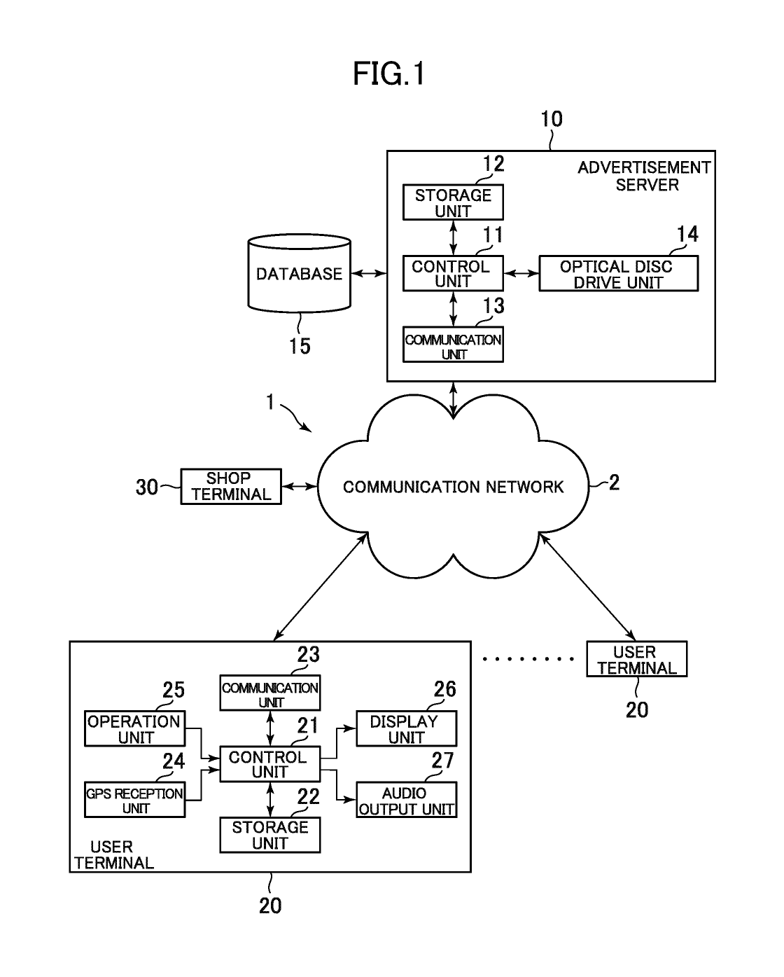

A first embodiment of the present invention is described. FIG. 1 is a diagram for illustrating an example of the overall configuration of an advertisement system according to the first embodiment of the present invention. An advertisement system. 1 according to this embodiment includes, as illustrated in FIG. 1, an advertisement server 10 (advertisement processing device), a database 15, a user terminal 20, and a shop terminal 30.

The advertisement server 10, the user terminal 20, and the shop terminal 30 are connected to a communication network 2. Two-way data communication can be executed between the advertisement server 10 and the user terminal 20. Further, the advertisement server 10 and the shop terminal 30 can execute two-way data communication as well between themselves.

The advertisement server 10 is a server configured to provide electronic advertisements. The advertisement server 10 includes a control unit 11, a storage unit 12, a communication unit 13, and an optical disc drive unit 14. The control unit 11 includes, for example, one or more microprocessors and executes processing as instructed by an operating system or a program that is stored in the storage unit 12. The storage unit 12 includes a main memory unit and an auxiliary storage unit. For example, the main memory unit is a RAM and the auxiliary storage unit is a hard disk, a solid state drive, or the like.

The communication unit 13 is configured to execute data communication via the communication network 2. The optical disc drive unit 14 reads a program and data stored on an optical disc (information storage medium). Programs and data are supplied to the storage unit 12 via the communication network 2. Alternatively, programs and data are supplied to the storage unit 12 via an optical disc. Specifically, a program or data stored on an optical disc is read by the optical disc drive unit 14 and stored in the storage unit 12.

Note that the advertisement server 10 may include a component configured to read a program or data that is stored in information storage media other than optical discs (for example, memory cards). Then, programs and data may be supplied to the storage unit 12 via information storage media other than optical discs.

The advertisement server 10 is capable of accessing the database 15. The database 15 may be built in the advertisement server 10, or may be built in a server other than the advertisement server 10. Information necessary to provide electronic advertisements is stored in the database 15.

The user terminal 20 is an information processing device used by a user. The user terminal 20 is a portable information processing device that can be carried around by the user, such as a cellular phone (including smartphones), a portable information terminal (including tablet computers), a laptop personal computer, or the like. Note that the user terminal 20 in the following description is assumed to be a cellular phone (smartphone).

The user terminal 20 includes a control unit 21, a storage unit 22, a communication unit 23, a GPS reception unit 24, an operation unit 25, a display unit 26, and an audio output unit 27. The control unit 21 and the storage unit 22 are the same as the control unit 11 and the storage unit 12 of the advertisement server 10, respectively.

The communication unit 23 is configured to execute data communication via the communication network 2. The communication unit 23 has, for example, a data communication function that utilizes a cellular phone communication network, and is capable of executing data communication via cellular phone base stations set up in each place. In another example, the data communication unit 23 has a data communication function that is in conformity to wireless LAN standards, and is capable of executing data communication via wireless LAN base stations (access points) set up in each place.

The GPS reception unit 24 receives signals transmitted from a plurality of GPS satellites. An operating system of the user terminal 20 obtains position information (the latitude and longitude) of the user terminal 20 based on the signals received by the GPS reception unit 24.

Note that the operating system of the user terminal 20 may obtain the position information of the user terminal 20 based on position information of a cellular phone base station that is communicating with the user terminal 20. Alternatively, the operating system of the user terminal 20 may obtain the position information of the user terminal 20 based on position information of a wireless LAN base station that is communicating with the user terminal 20.

The operating system of the user terminal 20 obtains the position information of the user terminal 20 at a given time interval. Further, the position information can be utilized by an application program that is run on the user terminal 20.

The operation unit 25 is for a user to operate. In the case where the user terminal 20 is a cellular phone or a portable information terminal, for example, buttons (keys), a stick, a touch panel, or the like that is provided on the cellular phone or the portable information terminal corresponds to the operation unit 25. Further, in the case where the user terminal 20 is a personal computer, keys, a stick, a touch pad, a mouse, or the like that is provided on the personal computer corresponds to the operation unit 25.

In the following description, it is assumed that the user terminal 20 has a touch panel overlaid on the display unit 26 and that the user operates the user terminal 20 with the use of the touch panel. Specifically, the description is given with the assumption that the user selects (designates) an object displayed on the display unit 26 by touching the touch panel with a finger or a touch pen.

The display unit 26 is, for example, a liquid crystal display panel, an organic EL display panel, or the like, and displays various screens as instructed by the control unit 21. The audio output unit 27 is, for example, a speaker, earphones, headphones, or the like, and outputs various kinds of audio as instructed by the control unit 21.

Note that the program and data are supplied to the storage unit 22 via the communication network 2. The user terminal 20 may include a component configured to read a program or data that is stored in an information storage medium (for example, a memory card slot unit, an optical disc drive unit, or the like). Then, programs and data may be supplied to the storage unit 22 via an information storage medium.

The shop terminal 30 is an information processing device that is used at a shop of an advertiser, and is, for example, a personal computer or the like. As the user terminal 20, the shop terminal 30 includes a control unit, a storage unit, a communication unit, an operation unit, a display unit, and others. Further, the shop terminal 30 has a function of reading a code image that is displayed on the display unit 26 of the user terminal 20 in order to, for example, accept the use of an electronic coupon.

In this embodiment, a daemon (for example, an HTTP daemon) that receives a processing request from the user terminal 20 or the shop terminal 30 is activated on the advertisement server 10. On the user terminal 20 or the shop terminal 30, on the other hand, an application program for accessing the advertisement server 10 is activated and transmits a processing request (for example, an HTTP request) to the advertisement server 10.

Data about the result of processing executed in response to the processing request (for example, an HTTP response) is then transmitted from the advertisement server 10 to the user terminal 20 or the shop terminal 30. For example, page data written in a Web page description language is transmitted to the user terminal 20 or the shop terminal 30. The user terminal 20 or the shop terminal 30 displays, based on the page data, a screen (Web page) that is based on the processing result.

The advertisement system 1 configured as described above provides electronic advertisements to users. Electronic coupons or electronic fliers, for example, are provided to users. In other words, the advertisement system 1 provides coupons or fliers electronically to users, which can further be rephrased as providing coupon data or flier data to users.

The following description takes, as an example, a case of providing electronic coupons to users. A “coupon” is a ticket for receiving a privilege at a shop (real shop). For example, a “coupon” is a discount ticket for getting a discount when purchasing a product, or using a service, at a shop, or a voucher that can be exchanged for an item or a given service at a shop.

For example, whether or not a user has entered a vicinity region of a shop is determined based on the position information of the user terminal 20 and, in the case where the user has entered a vicinity region of the shop, an electronic coupon that can be used at the shop is given to the user. Further, an electronic coupon may be given to a user also when the user purchases a product at a shop or when the user uses a service at a shop, for example. Note that any method can be employed as a method to give a user an electronic coupon directly from a shop.

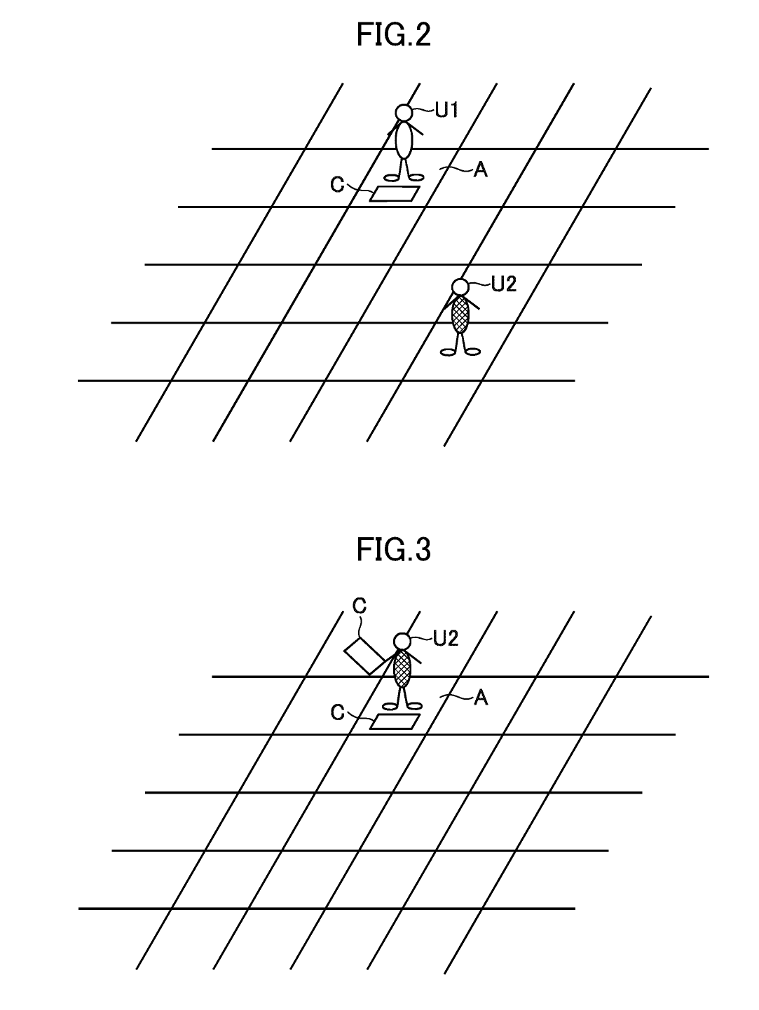

In particular, in the advertisement system 1 according to this embodiment, it is possible to distribute an electronic coupon obtained by a user to another user. FIG. 2 and FIG. 3 are diagrams for illustrating the outline of this function.

The advertisement system 1 according to this embodiment, it is possible to virtually put an electronic coupon that the user possesses in a region in the real space. As illustrated in FIG. 2, a user U1 who possesses an electronic coupon C moves to a region A or the vicinity of the region A, activates an application program on the user terminal 20, and performs given operation, to thereby associate the electronic coupon C with the region A.

Further, by moving to the region to which an electronic coupon is virtually put by another user, a user can obtain that electronic coupon. As illustrated in FIG. 3, a user U2 moves to the region A, which is associated with the electronic coupon C by the user U1, activates an application program on the user terminal 20, and performs given operation, to thereby obtain the electronic coupon C.

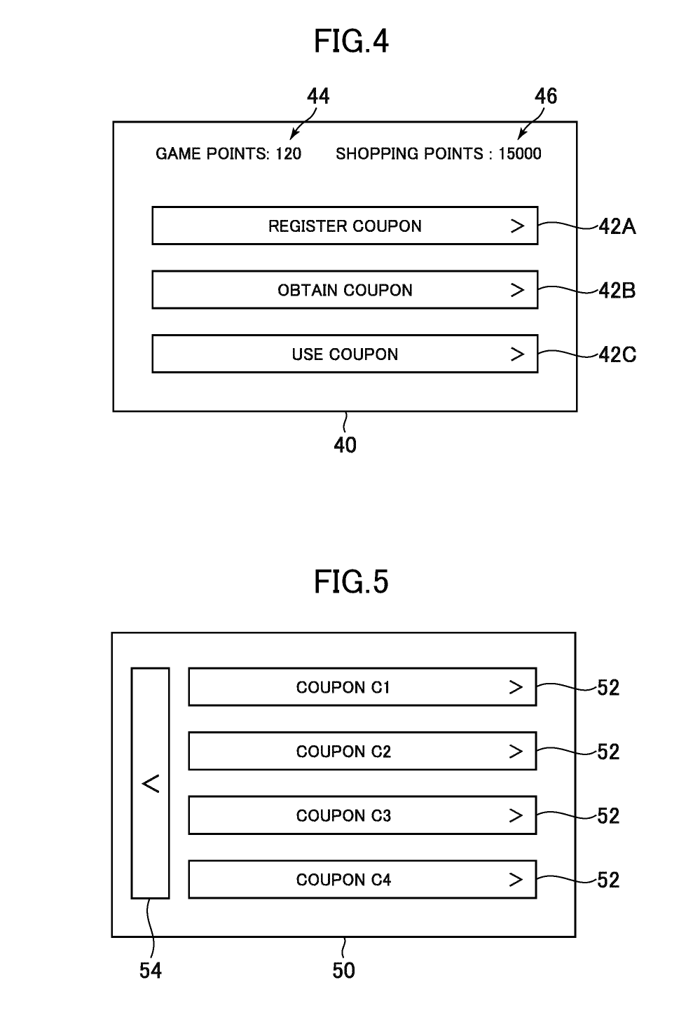

Operation to be performed by a user is described below. FIG. 4 to FIG. 9 are diagrams for illustrating this operation, and FIG. 4 to FIG. 7 and FIG. 9 are each an example of a screen displayed on the display unit 26 of the user terminal 20. These screens are displayed as a result of data communication between the user terminal 20 and the advertisement server 10. Further, the description is given here with an assumption that the user is holding the user terminal 20 so that the display unit 26 looks long horizontally from the viewpoint of the user.

To use a service provided by the advertisement server 10, the user activates on the user terminal 20 an application program for accessing the advertisement server 10. When the application program is activated, a menu screen is displayed after a user authentication is executed.

FIG. 4 is an example of the menu screen. A menu screen 40 of FIG. 4 displays three menu buttons, 42A, 42B, and 42C, a game point field 44, and a shopping point field 46. Note that the game point field 44 indicates the current game points of the user. Further, the shopping point field 46 indicates remaining shopping points that the user has at present. Shopping points can be used at a real shop or a virtual shop. Specifically, the user can redeem shopping points for all or part of the price of a product purchased or a service received. Details of the game points and the shopping points are described later.

A series of operation steps for virtually putting an electronic coupon in a region in the real space is described first. In other words, a series of operation steps for associating an electronic coupon with a region in the real space is described. In the following description, “virtually putting an electronic coupon in a region in the real space” or “associating an electronic coupon with a region in the real space” is expressed as “registering an electronic coupon to a region in the real space”.

The menu button 42A is a button for registering an electronic coupon to a region in the real space. When the menu button 42A is selected, a coupon list screen is displayed.

FIG. 5 is an example of the coupon list screen. This coupon list screen 50 is a screen displaying a list of electronic coupons that the user possesses at present. The coupon list screen 50 of FIG. 5 displays a plurality of coupon buttons 52 and a back button 54. The back button 54 is a button for returning to the menu screen 40.

Each coupon button 52 corresponds to each of electronic coupons that the user possesses. FIG. 5 indicates that the user possesses four electronic coupons, C1, C2, C3, and C4.

The user selects, on the coupon list screen 50, an electronic coupon that he wants to register to a region in the real space (hereinafter referred to as “registration target electronic coupon”). Specifically, the user selects a registration target electronic coupon by selecting one of the coupon buttons 52. When a registration target electronic coupon is selected, a coupon screen is displayed.

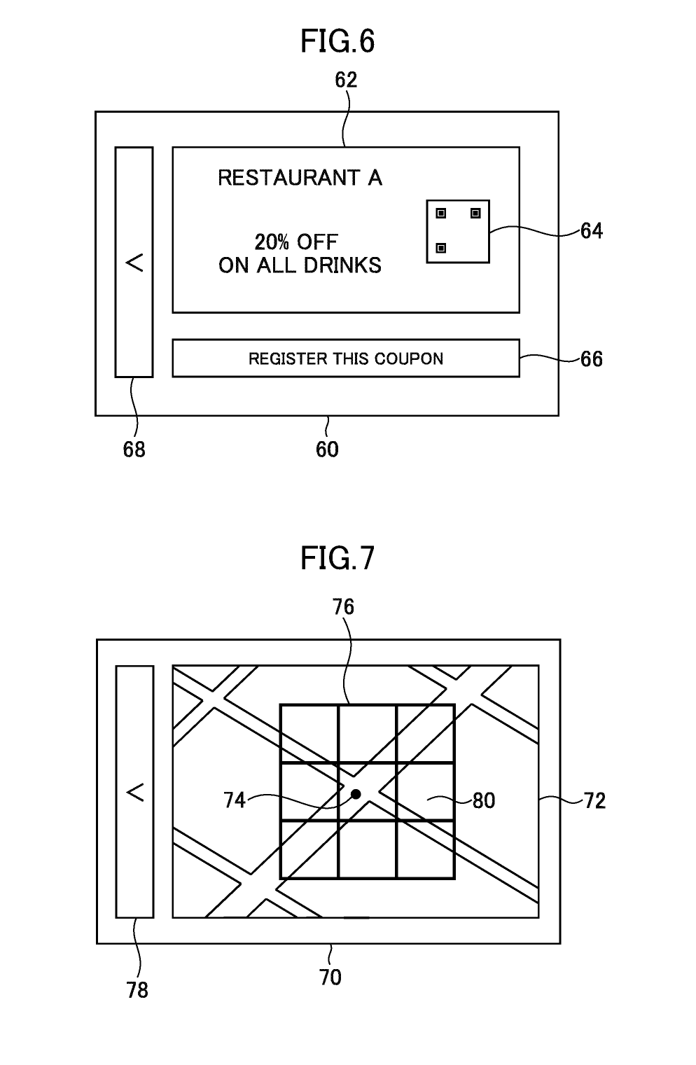

FIG. 6 is an example of the coupon screen. A coupon screen 60 is a screen that displays details of a registration target electronic coupon. The coupon screen 60 of FIG. 6 displays a coupon 62. Specifically, a shop at which the electronic coupon can be used and the specifics of a privilege that is granted by the electronic coupon are displayed. Further, the coupon screen 60 displays a code image 64. The code image 64 is an image in which identification information about an electronic coupon is made into a code.

The coupon screen 60 also displays a registration button 66 and a back button 68. The back button 68 is a button for returning to the coupon list screen 50. The user selects the registration button 66 in the case where the electronic coupon that is displayed on the coupon screen 60 is determined as a registration target electronic coupon. When the registration button 66 is selected, a section designating screen is displayed.

FIG. 7 is an example of the section designating screen. A section designating screen 70 is a screen for designating a region to which an electronic coupon is registered (hereinafter referred to as “registration target region”). The section designating screen 70 of FIG. 7 displays a back button 78. The back button 78 is a button for returning to the coupon screen 60.

The section designating screen 70 of FIG. 7 also displays a map 72 of the surroundings of a user position (latest position) 74. The map 72 is displayed so that, for example, the user position 74 is displayed at the center of the map 72. Though omitted in FIG. 7, information such as place names, road names, facility names and the likes are displayed on the map 72, actually.

Further, on the map 72, the section designating screen 70 displays a candidate region 76, which is a candidate for the registration target region. The user designates a partial region of the candidate region 76 as a registration target region.

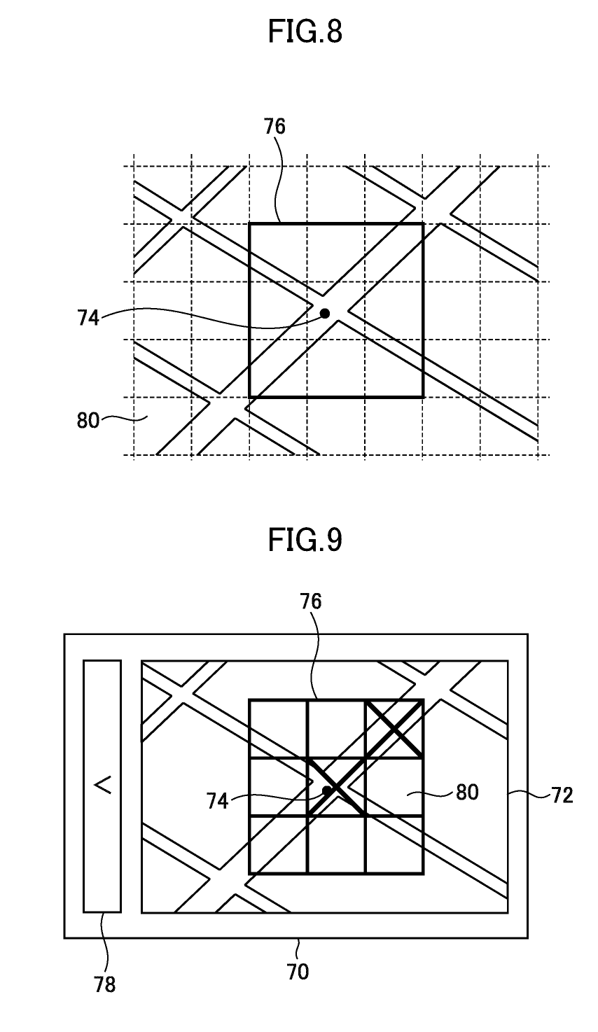

FIG. 8 is a diagram for illustrating the candidate region 76. In the advertisement system 1, the real space (a map) is sectioned into a plurality of rectangular sections 80 in advance as illustrated in FIG. 8. Then, an aggregation of the section 80 that includes the user position 74 and eight sections 80 surrounding this section 80 (namely, eight sections 80 adjacent to the upper, lower, left, right, upper left, upper right, lower left, and lower right sides of this section 80) is set as the candidate region 76.

On the section designating screen 70, the user designates one of the nine sections 80 included in the candidate region 76 as a registration target region. When the user designates one of the sections 80 as a registration target region, the designated section 80 is associated with the registration target electronic coupon, and the electronic coupon is registered to the designated section 80.

Note that a plurality of different electronic coupons can be registered to one section 80, whereas registering a plurality of identical electronic coupons to one section 80 is not permitted. The section designating screen 70 therefore displays the section 80 to which the same electronic coupon as a registration target electronic coupon is already registered in a distinguishable manner, and such a section 80 cannot be designated as a registration target region.

FIG. 9 is an example of how the section designating screen 70 looks in this case. In the example of FIG. 9, two oblique lines, one dropping to the right and the other dropping to the left, are overlaid on each of the center section 80 and the upper right section 80 to indicate that these sections 80 cannot be designated as a registration target region. Alternatively, the section designating screen 70 may be configured so as not to display a section 80 as above.

Note that an expiration date is set to the registration of an electronic coupon. For instance, when a given length of time (e.g., 3 hours) elapses since the registration of an electronic coupon by one user to the section 80, another user is allowed to register an identical electronic coupon. The registration of the electronic coupon by the former user remains valid, even after the elapse of the given length of time as above, until another user registers the electronic coupon. When another user registers the electronic coupon, the registration of the electronic coupon by the former user is invalidated.

A series of operation steps for obtaining an electronic coupon that has been registered to a region in the real space is described next. The menu button 42B of FIG. 4 is a button for obtaining an electronic coupon that has been registered to a region in the real space. When the menu button 42B is selected, the coupon list screen is displayed.

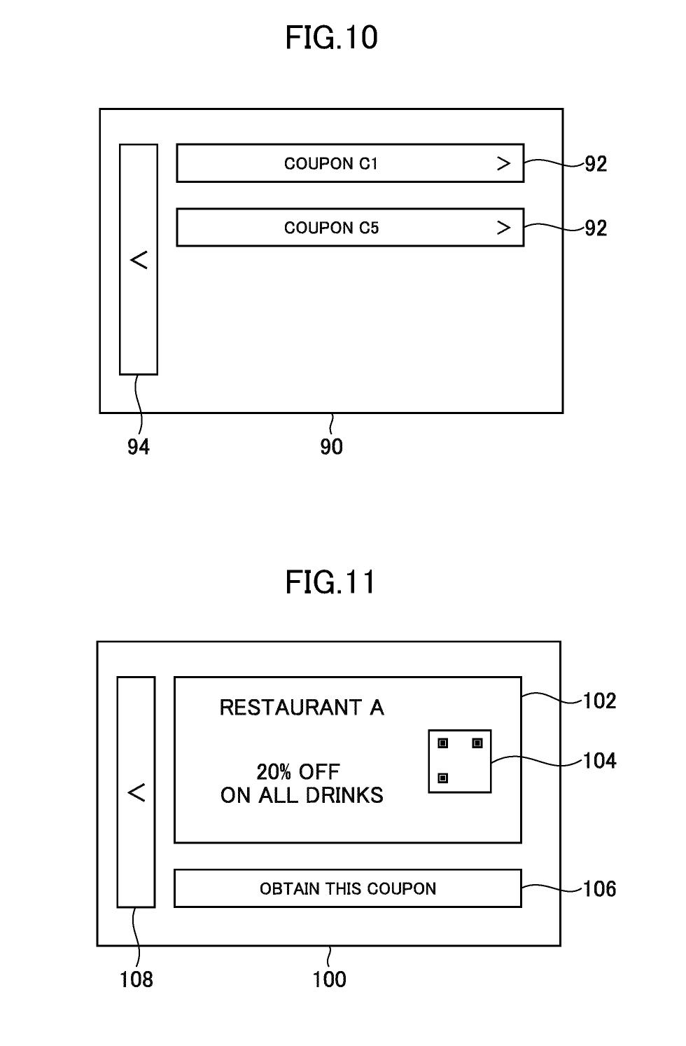

FIG. 10 is an example of a coupon list screen in this case. This coupon list screen 90 is a screen displaying a list of electronic coupons registered to the section 80 where the user is located at present. The coupon list screen 90 of FIG. 10 displays a plurality of coupon buttons 92 and a back button 94. The back button 94 is a button for returning to the menu screen 40.

Each coupon button 92 corresponds to each of electronic coupons registered to the section 80 where the user is located at present. In FIG. 10, a case is given where two electronic coupons, C1 and C5, are registered to the section 80 where the user is located at present.

The user selects on the coupon list screen 90 an electronic coupon that the user wishes to obtain (hereinafter referred to as “obtaining target electronic coupon”). Specifically, the user selects an obtaining target electronic coupon by selecting one of the coupon buttons 92. When an obtaining target electronic coupon is selected, a coupon screen is displayed.

FIG. 11 is an example of a coupon screen. A coupon screen 100 is a screen that displays details of an obtaining target electronic coupon. The coupon screen 100 of FIG. 11 displays a coupon 102. Further, a code image 104 is displayed. The coupon 102 and the code image 104 are the same as the coupon 62 and the code image 64 illustrated in FIG. 6.

The coupon screen 100 displays an obtaining button 106 and a back button 108. The back button 108 is a button for returning to the coupon list screen 90. When the user selects the obtaining button 106, the obtaining target electronic coupon is given to the user.

In the case where an electronic coupon registered by the user U1 is obtained by the user U2, for example, points are added to the game points of the user U1. Game points of a user thus increase each time an electronic coupon registered by the user is obtained by another user. Further, the advertisement system 1 publishes the game point ranking of users.

Described next is a series of operation steps for enabling the user to use an electronic coupon at a shop. The menu button 42C of FIG. 4 is a button for using an electronic coupon. When the menu button 42C is selected, the coupon list screen 50 (FIG. 5) is displayed.

The user selects one of the coupon buttons 52 on the coupon list screen 50, to thereby select an electronic coupon that the user uses at a shop. When one of the electronic coupons is selected, a coupon screen that displays details of the selected electronic coupon is displayed. This coupon screen is similar to the coupon screen 60 of FIG. 6, except that the registration button 66 is not displayed in this case.

When the user taps the code image 64 on the coupon screen, he displayed code image 64 is shown enlarged. The user can use the electronic coupon by presenting the enlarged code image 64 to the shop's clerk. When the code image 64 is read by the shop terminal 30, the fact that the electronic coupon has been used is notified to the advertisement server 10.

In the case where the user U2 obtains an electronic coupon registered by the user U1 and uses it at a shop by, for example, points are added to the shopping points of the user U1. Shopping points of a user thus increase each time an electronic coupon registered by the user is used by another user.

In the advertisement system 1 described above, a place where an electronic coupon can be registered by a user is limited based on the user's position, and a user therefore needs to actually visit the place to which he registers an electronic coupon or the vicinity of that place. Indiscriminate registration of a huge number of electronic advertisements is prevented as a result.

In the advertisement system 1, because a place where an electronic coupon can be registered is set based on the user's position, a user needs to actually visit a place to which he registers an electronic coupon or the vicinity of that place, and this makes it difficult to register an electronic coupon to a place without actually seeing that place. Registering an electronic coupon to a place unsuitable as the setting where electronic coupons are provided is prevented as a result.

Further, the advertisement system. 1 sets, as a place to which an electronic coupon can be registered, not only the section 80 that includes the user's position but also the sections 80 in the vicinity of that section 80. This guarantees the convenience of users. In the case where a user wishes to register an electronic coupon to a place across a large intersection, for example, the user is allowed to register the electronic coupon without actually crossing over to the other side of the intersection.

In addition, the advertisement system 1 sets, as a place to which an electronic coupon can be registered, not only the section 80 that includes the user's position but also the sections 80 in the vicinity of that section 80. Such a configuration guarantees that at least one section 80 in which a road runs is set as a place to which an electronic coupon can be registered. In other words, at least one place where there is traffic of men is presented as a place to which an electronic coupon can be registered.

Further, an electronic coupon is registered to a region (one section 80) instead of a position in the advertisement system 1. In such a system, registering a plurality of identical coupons to places close to one another needs to be avoided. Regarding this, in the case where an electronic coupon is registered to a region, when registering an electronic coupon to a region, it is only necessary to check whether or not the same electronic coupon is registered to that region or not. In the case where an electronic coupon is registered to a position, on the other hand, when registering a coupon to a position, it is necessary to search for the same electronic coupon registered to the vicinity of that position. Registering an electronic coupon to a region thus enables to simplify processing compared to the case where an electronic coupon is registered to a position.

Further, the advertisement system 1 awards game points to a user when an electronic coupon registered by that user is obtained by another user. Moreover, the advertisement system 1 publishes the game point ranking of users. As a result, a fun to compete for an amount of game points is given for users.

Further, the advertisement system 1 awards shopping points to a user when an electronic coupon registered by that user is obtained and used by another user.

In the advertisement system 1, for earning more game points and shopping points, users are motivated to register electronic coupons to more places or to register electronic coupons to places where it is likely that a registered coupon is obtained by more other users. Electronic advertising is performed actively and efficiently as a result.

Note that an electronic coupon may be used repeatedly, or an electronic coupon may be consumed once it is used. Further, it may be configured that a user is only allowed to register electronic coupons that are not used by that user himself. Also, it may be configured that once a user registers an electronic coupon, that coupon is set no longer usable. Moreover, the number of times that an electronic coupon can be used may be limited, and the number of times that an electronic coupon can be registered may be limited.

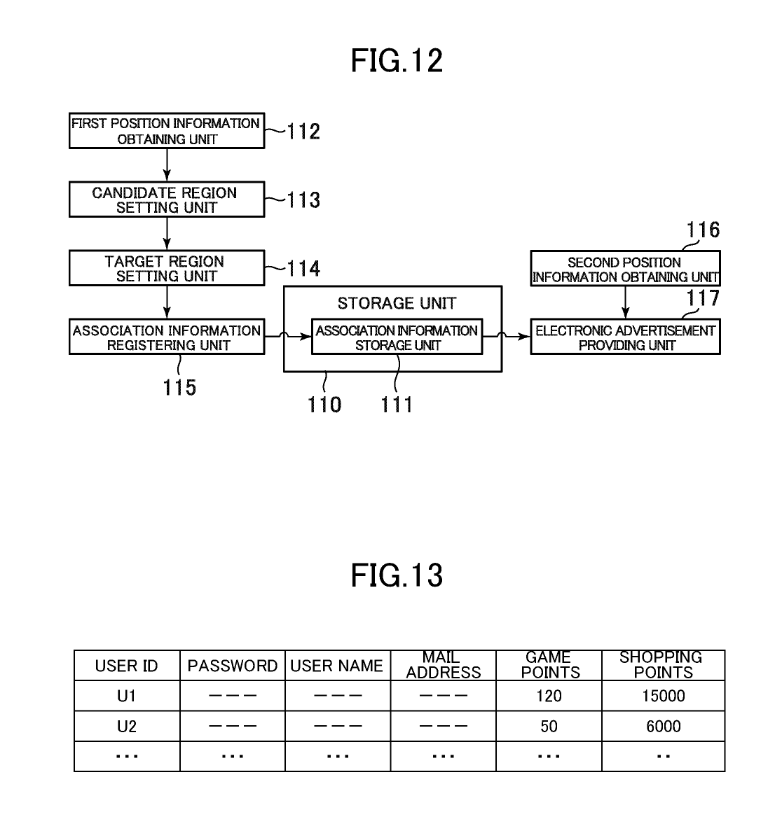

Function blocks implemented in the advertisement system 1 are described next. FIG. 12 is a function block diagram for illustrating function blocks that are implemented in the advertisement system 1. As illustrated in FIG. 12, the advertisement system 1 includes a storage unit 110, a first position information obtaining unit 112, a candidate region setting unit 113, a target region setting unit 114, an association information registering unit 115, a second position information obtaining unit 116, and an electronic advertisement providing unit 117.

For example, the storage unit 110 is implemented by the database 15 and the function blocks other than the storage unit 110 are implemented by the control unit 11 of the advertisement server 10. In other words, the control unit 11 functions as the function blocks other than the storage unit 110 by executing processing according to by a program.

The storage unit 110 is described first. The storage unit 110 stores information necessary to provide electronic advertisements. The storage unit 110 includes an association information storage unit 111. The association information storage unit 111 stores association information, which indicates association between an electronic advertisement and a region in the real space.

FIG. 13 to FIG. 19 are diagrams for showing an example of information that is stored in the storage unit 110. FIG. 13 is an example of a user table. The user table is a list of users who use services provided by the advertisement server 10. The user table includes, for example, a “user ID” field, a “password” field, a “user name” field, a “mail address” field, a “game point” field, and a “shopping point” field.

The “user ID” field indicates identification information for uniquely identifying a user. The “password” field indicates a password specified by the user. The “user name” field and the “mail address” field indicate the user's name and mail address, respectively. The “game point” field indicates the game points of the user. The “shopping point” field indicates the remaining shopping points that the user has.

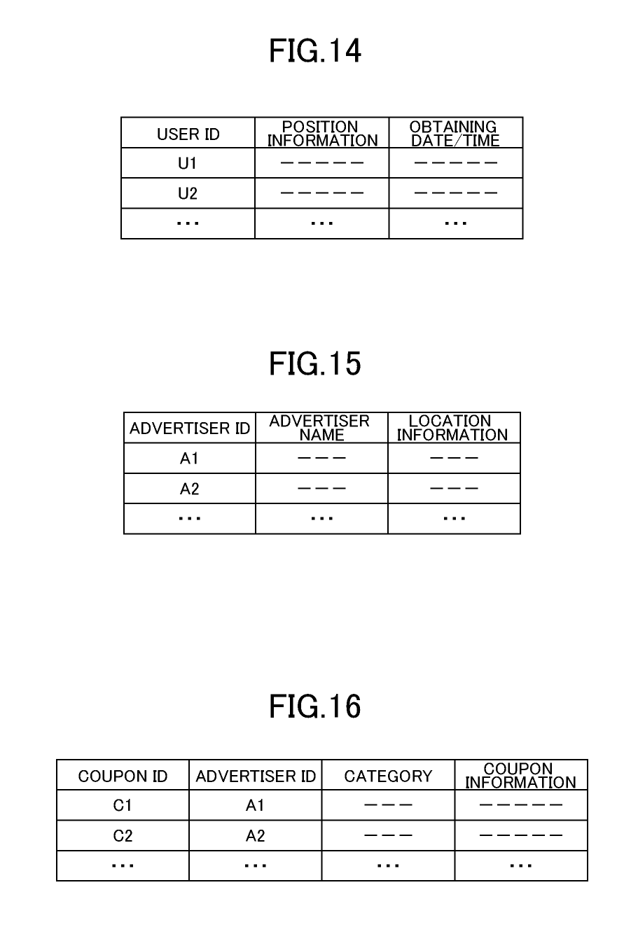

FIG. 14 is an example of a user position table. The user position table shows position information of each user. The user position table includes, for example, a “user ID” field, a “position information” field, and an “obtaining date/time” field.

The “user ID” field indicates the user ID of a user. In the “position information” field, position information that has been received from the user terminal 20 is stored. The “obtaining date/time” field indicates a date/time at which the position information has been obtained.

In the advertisement system 1, an application program activated on the user terminal 20 regularly transmits position information of the user terminal 20 to the advertisement server 10. For example, the latest position information is transmitted to the advertisement server 10 each time position information is obtained. To give another example, the latest position information is transmitted to the advertisement server 10 at a given time interval. In still another example, the latest position information is transmitted to the advertisement server 10 when the cellular phone base station to which the user terminal 20 is connected for communication is switched to another cellular phone base station. The “position information” field stores latest position information received from the user terminal 20.

In the case where the latest position information is transmitted to the advertisement server 10 at a given time interval, the transmission interval for when the application program is active (i.e., when a screen of the application program is displayed on the display unit 26) may be different from the transmission interval for when the application program is not active. For instance, the latest position information may be transmitted to the advertisement server 10 at a first time interval (e.g., 5 minutes) when the application program is active, and at a second time interval (e.g., 15 minutes), which is longer than the first time interval, when the application program is not active.

FIG. 15 is an example of an advertiser table. The advertiser table is a list of advertisers who use services provided by the advertisement server 10. The advertiser table includes, for example, an “advertiser ID” field, an “advertiser name” field, and a “location information” field.

The “advertiser ID” field indicates identification information for uniquely identifying an advertiser. The “advertiser name” field indicates the name of the advertiser. The “location information” field stores information that indicates the location of a shop run by the advertiser.

FIG. 16 is an example of an electronic coupon table. The electronic coupon table is a list of electronic coupons provided by the advertisement server 10. The electronic coupon table includes, for example, a “coupon ID” field, an “advertiser ID” field, a “category” field, and a “coupon information” field.

The “coupon ID” field indicates identification information for uniquely identifying an electronic coupon. The “advertiser ID” field indicates an advertiser ID assigned to the provider of the electronic coupon (advertiser). The “category” field indicates a category to which the electronic coupon belongs. The “coupon information” field stores information that indicates the specifics of the electronic coupon.

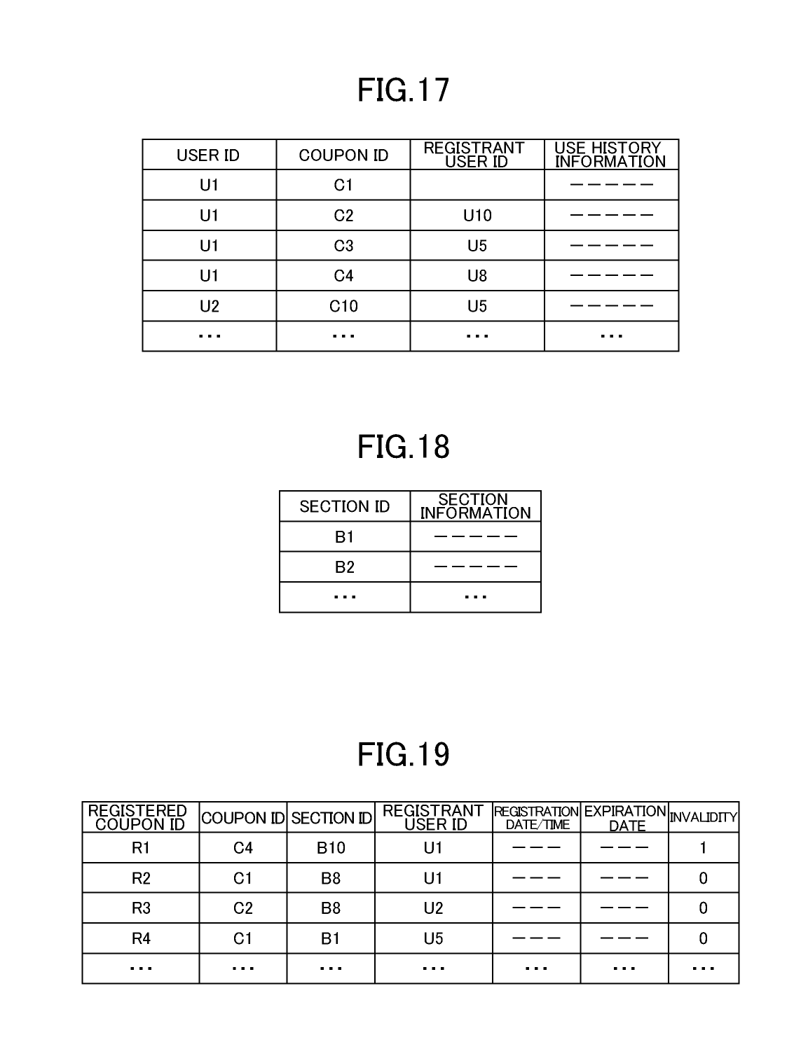

FIG. 17 is an example of a possession status table. The possession status table is a list of electronic coupons that each user possesses. The possession status table includes, for example, a “user ID” field, a “coupon ID” field, a “registrant user ID” field, and a “use history information” field.

The “user ID” field indicates the user ID of a user. The “coupon ID” field indicates the coupon ID of an electronic coupon. In the case where an electronic coupon registered by another user is obtained by the user, the user ID of the other user who has registered the electronic coupon is stored in the “registrant user ID” field. The “use history information” field stores information that indicates the use history of the electronic coupon by the user.

FIG. 18 is an example of a section table. The section table is a list of the plurality of sections 80 set in the real space. The section table includes, for example, a “section ID” field and a “section information” field.

The “section ID” field indicates identification information for uniquely identifying a section 80. Information for designating the section 80 is registered in the “section information” field. A section 80 is a rectangular region of a fixed size, and information that indicates the position (e.g., the latitude and the longitude) of a representative point (e.g., the center point, the upper left vertex, or the like) of the section 80 is stored in the “section information” field.

FIG. 19 is an example of a registration status table. The registration status table is a list of electronic coupons registered to regions in the real space. The registration status table includes, for example, a “registered coupon ID” field, a “coupon ID” field, a “section ID” field, a “registrant user ID” field, a “registration date/time” field, an “expiration date” field, and an “invalidity” field.

The “registered coupon ID” field indicates identification information for uniquely identifying an electronic coupon that is registered. The “coupon ID” field indicates the coupon ID of the registered electronic coupon. The “section ID” field indicates the section ID of the section 80 to which the electronic coupon is registered. The “registrant user ID” field indicates the user ID of a user who has registered the electronic coupon.

The “registration date/time” field indicates a date/time at which the electronic coupon has been registered. The “expiration date” field indicates the expiration date of the registered electronic coupon. For example, another date/time is registered, which is after an elapse of a given length of time (e.g., 3 hours) from the registration date/time, in the “expiration date” field.

The “invalidity” field indicates whether or not the registered electronic coupon is invalid. For example, a value “0” or “1” is registered in the “invalidity” field. The value “0” indicates that the electronic coupon is valid, and the value “1” indicates that the electronic coupon is invalid. The initial value of the “invalidity” field is set to “0”, and the value of the “invalidity” field is updated from “0” to “1” once it has passed the expiration date of the registered electronic coupon.

Note that each record in the registration status table described above shows an association between an electronic coupon and a section 80 (a region in the real space), and accordingly corresponds to the “association information” described above.

Described next are function blocks that enable a user to associate an electronic advertisement (for example, an electronic coupon) with a region in the real space (for example, a section 80). The first position information obtaining unit 112, the candidate region setting unit 113, the target region setting unit 114, and the association information registering unit 115 correspond to these function blocks.

The first position information obtaining unit 112 is described. The first position information obtaining unit 112 obtains first position information, which is about the position of a first user.

Note that “First position information” is, for example, information that indicates the latest position of the user. The “first position information” may instead be information that indicates the current position of the user, or may be information that indicates a past position of the user (a position at a point in time that precedes the current time, or a position at a point in time that precedes the point in time when the latest position is obtained). Alternatively, the “first position information” may be information that indicates the current position and the past position of the user.

As described above, in this embodiment, position information of the user terminal 20 is transmitted regularly to the advertisement server 10 and the latest position information is stored in the user position table. The first position information obtaining unit 112 accordingly reads position information that is associated with the user ID of the first user out of the user position table, and obtains the read information as the “first position information” described above.

Note that instead of regularly transmitting position information of the user terminal 20 to the advertisement server 10, the user terminal 20 may transmit the latest position information to the advertisement server 10 when an operation of making a request to associate an electronic advertisement with a region in the real space is performed.

In the case of FIG. 4 to FIG. 9, for example, an operation of selecting the registration button 66 on the coupon screen 60 corresponds to the “operation of making a request to associate an electronic advertisement with a region in the real space”. The user terminal 20 may therefore transmit the latest position information to the advertisement server 10 when the registration button 66 is selected. The first position information obtaining unit 112 in this case receives the position information transmitted from the user terminal 20 and obtains the received position information as the “first position information” described above.

Note that instead of transmitting information that indicates the position itself of the user terminal 20 to the advertisement server 10, the user terminal 20 may transmit basic information for obtaining the position of the user terminal 20 to the advertisement server 10.

For example, the user terminal 20 may transmit information indicating a signal that is received by the GPS reception unit 24 to the advertisement server 10. Alternatively, the user terminal 20 may instead transmit position information of a cellular phone base station that is communicating with the user terminal 20 to the advertisement server 10. Still alternatively, the user terminal 20 may transmit position information of a wireless LAN base station that is communicating with the user terminal 20 to the advertisement server 10.

The first position information obtaining unit 112 in this case obtains (calculates) position information of the user terminal 20 based on the above information transmitted from the user terminal 20, and obtains this position information as the “first position information” described above.

The candidate region setting unit 113 is described. The candidate region setting unit 113 sets a candidate region, which is a candidate for a region to be associated with an electronic advertisement, based on the first position information obtained by the first position information obtaining unit 112.

The candidate region setting unit 113 sets, as a candidate region, a region that is a vicinity region of a position indicated by the first position information and that includes this position. For example, the candidate region setting unit 113 sets a region that includes a plurality of partial regions as a candidate region. More specifically, the candidate region setting unit 113 sets a region that includes a partial region where a position indicated by the first position information is included and a plurality of partial regions located in the vicinity of this partial region as a candidate region.

In the case of FIG. 4 to FIG. 9, for example, the candidate region setting unit 113 sets an aggregation of the section 80 that includes a position indicated by the first position information and a plurality of sections 80 in the vicinity of this section 80 as the candidate region 76. In this case, each of the sections 80 corresponds to the “partial region”.

For example, the candidate region setting unit 113 sets an aggregation of the section 80 that includes a position indicated by the first position information and eight sections 80 that surround this section 80 from eight directions as the candidate region 76. In other words, the candidate region setting unit 113 sets, as the candidate region 76, an aggregation of the section 80 that includes a position indicated by the first position information and eight sections 80 that are adjacent to the upper, lower, left, right, upper left, upper right, lower left, and lower right sides of this section 80.

Further, the candidate region setting unit 113 may instead set an aggregation of the section 80 that includes a position indicated by the first position information and four sections 80 that surround this section 80 from four adjacent positions as the candidate region 76. In other words, the candidate region setting unit 113 may set, as the candidate region 76, an aggregation of the section 80 that includes a position indicated by the first position information and four sections 80 that are adjacent to the upper, lower, left, and right sides of this section 80.

In the case where the candidate region includes a region to which an electronic advertisement having a given relationship with the registration target electronic advertisement is already registered, the candidate region setting unit 113 may exclude this region from the candidate region.

Now, an “electronic advertisement having a given relationship with the registration target electronic advertisement” is, for example, an “electronic advertisement that is the same as the registration target electronic advertisement”. Alternatively, an “electronic advertisement having a given relationship with the registration target electronic advertisement” is an “electronic advertisement that belongs to the same category as the registration target electronic advertisement”.

In the case of FIG. 4 to FIG. 9, for example, the candidate region setting unit 113 excludes, from the candidate region 76, the section 80 to which the same electronic coupon as the registration target electronic coupon (i.e., the electronic coupon selected on the coupon list screen 50) is already registered.

In this case, it may be configured that the section 80 as above is not displayed on the section designating screen 70 or that the section 80 as above is displayed on the section designating screen 70 in a manner so that it is distinguishable from other sections 80. In the latter case, it is only necessary to configure that the designation of the section 80 as above is rejected.

The target region setting unit 114 is described. The target region setting unit 114 sets, as a region with which an electronic advertisement is to be associated (a registration target region), a partial region inside a candidate region set by the candidate region setting unit 113.

For example, the target region setting unit 114 presents the candidate region to the user and receives the designation of a position or a partial region inside the candidate region from the user. Then, the target region setting unit 114 sets a registration target region based on the position or the partial region designated by the user. In the case where a region that includes a plurality of partial regions is set as the candidate region, for example, the target region setting unit 114 presents the plurality of partial regions to the user and receives the designation of at least one of the plurality of partial regions from the user. Then, the target region setting unit 114 sets the at least one partial region designated by the user as a registration target region.

In the example of FIG. 4 to FIG. 9, for example, the target region setting unit 114 has the user terminal 20 display the section designating screen 70, to thereby present the candidate region 76 including a plurality of sections 80 to the user. Further, the target region setting unit 114 receives the designation of one of the plurality of sections 80 from the user. Then, the target region setting unit 114 sets the section 80 designated by the user as a registration target region.

The association information registering unit 115 is described next. The association information registering unit 115 registers association information, which indicates the association between a registration target electronic advertisement and a region set as a registration target region by the target region setting unit 114, in the association information storage unit 111.

In the example of FIG. 4 to FIG. 9, for example, the association information registering unit 115 adds, to the registration status table, a record that indicates the association between a registration target electronic coupon (i.e., the electronic coupon selected on the coupon list screen 50) and the section 80 that is the registration target (i.e., the section 80 designated on the section designating screen 70).

Function blocks that enable a user to obtain an electronic advertisement associated with a region in the real space are described next. The second position information obtaining unit 116 and the electronic advertisement providing unit 117 correspond to these function blocks.

The second position information obtaining unit 116 is described. The second position information obtaining unit 116 obtains second position information, which is about the position of a second user.

In this embodiment, position information of the user terminal 20 is transmitted regularly to the advertisement server 10 as described above, and the latest position information is stored in the user position table. Accordingly, the second position information obtaining unit 116 reads position information that is associated with the user ID of the second user out of the user position table, and obtains the read information as the “second position information”.

Note that instead of regularly transmitting position information of the user terminal 20 to the advertisement server 10, the user terminal 20 may transmit its latest position information to the advertisement server 10 when an operation of making a request to provide an electronic advertisement is performed.

In the examples of FIG. 10 and FIG. 11, for example, the operation of selecting the obtaining button 106 on the coupon screen 100 corresponds to the “operation of making a request to provide an electronic advertisement”. The user terminal 20 may therefore transmit its latest position information to the advertisement server 10 when the obtaining button 106 is selected. In this case, the second position information obtaining unit 116 receives the position information transmitted from the user terminal 20 and obtains the received position information as the “second position information” described above.

Note that instead of transmitting information that indicates the position itself of the user terminal 20 to the advertisement server 10, the user terminal 20 may transmit basic information for obtaining the position of the user terminal 20 to the advertisement server 10.

For example, the user terminal 20 may transmit information indicating a signal that is received by the GPS reception unit 24 to the advertisement server 10. Alternatively, the user terminal 20 may transmit, to the advertisement server 10, position information of a cellular phone base station that is communicating with the user terminal 20. Still alternatively, the user terminal 20 may transmit, to the advertisement server 10, position information of a wireless LAN base station that is communicating with the user terminal 20.

In this case, the second position information obtaining unit 116 obtains (calculates) position information of the user terminal 20 based on the above information transmitted from the user terminal 20, and obtains this position information as the “second position information” described above.

The electronic advertisement providing unit 117 is described. When a request to provide an electronic advertisement is received from a user (the second user), the electronic advertisement providing unit 117 extracts an electronic advertisement to be provided to this user from among electronic advertisements that are registered in the association information storage unit 111, based on regions registered in the association information storage unit 111 and the second position information obtained by the second position information obtaining unit 116, and provides the extracted electronic advertisement to the user.

In the example of FIG. 10 and FIG. 11, the electronic advertisement providing unit 117 provides, to the user, an electronic coupon registered to the section 80 that includes a position indicated by the second position information.

Note that the electronic advertisement providing unit 117 may provide the user also with electronic coupons that are registered to the sections 80 located in the vicinity of the section 80 that includes the position indicated by the second position information. For example, the electronic advertisement providing unit 117 may provide the user with electronic coupons that are registered to eight sections 80 surrounding the section 80 that includes the position indicated by the second position information as well.

Alternatively, the electronic advertisement providing unit 117 may provide the user with electronic coupons registered to the sections 80 that are within a reference distance from the position indicated by the second position information.

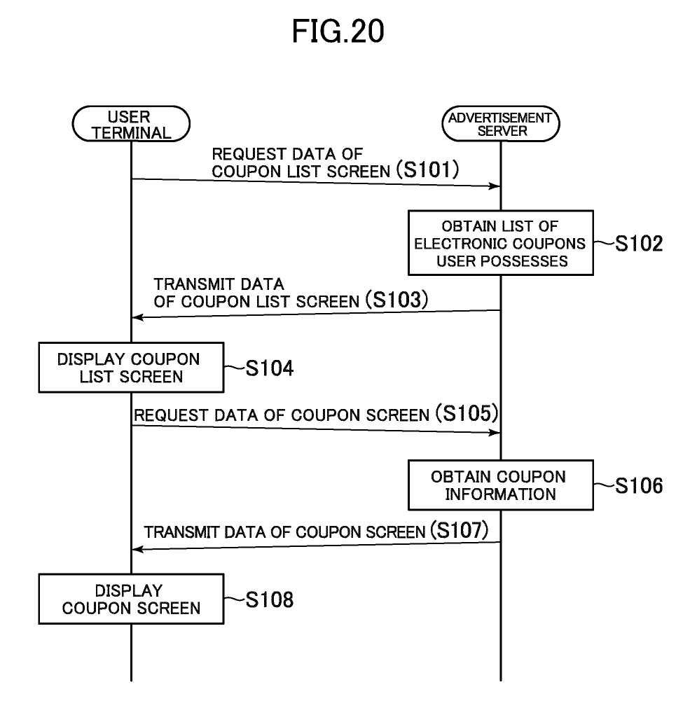

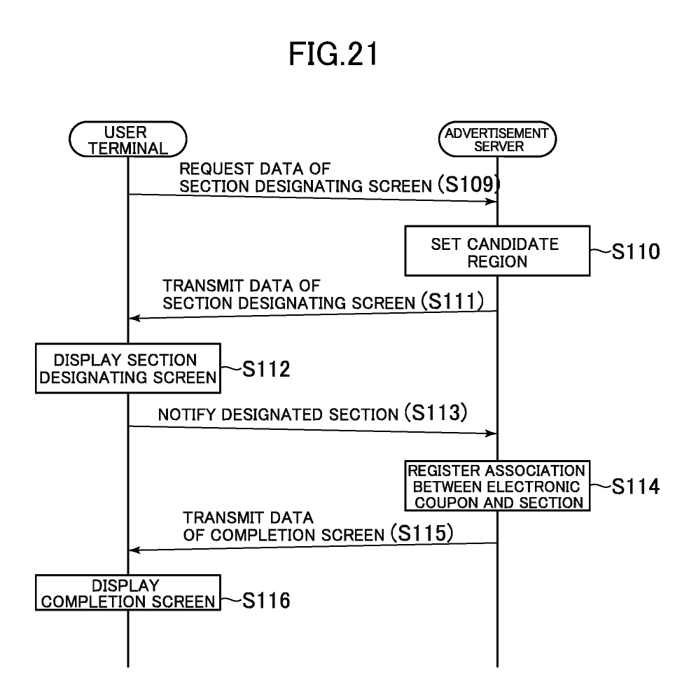

Processing executed in the advertisement system 1 is described next. FIG. 20 and FIG. 21 are diagrams for illustrating an example of processing that is executed when the menu button 42A of the menu screen 40 is selected. The control unit 11 of the advertisement server 10 executes the processing of FIG. 20 and FIG. 21 according to a program, to thereby function as the first position information obtaining unit 112, the candidate region setting unit 113, the target region setting unit 114, and the association information registering unit 115.

When the menu button 42A of the menu screen 40 is selected, the control unit 21 of the user terminal 20 requests data of the coupon list screen 50 to the advertisement server 10 (S101). In this case, the user ID of the user is transmitted to the advertisement server 10.

When the above request is received by the advertisement server 10, the control unit 11 of the advertisement server 10 obtains a list of electronic coupons that the user possesses (S102). The control unit 11 accesses the possession status table and obtains a record in which the user ID received from the user terminal 20 is stored in the “user ID” field, to thereby obtain a list of electronic coupons that the user possesses. Then, based on the obtained list, the control unit 11 generates data of the coupon list screen 50 and transmits the generated data to the user terminal 20 (S103). Further, based on this data, the control unit 21 of the user terminal 20 displays the coupon list screen 50 on the display unit 26 (S104).

The control unit 21 monitors whether or not any one of the coupon buttons 52 has been selected while the coupon list screen 50 is displayed on the display unit 26. In the case where one of the coupon buttons 52 is selected, the control unit 21 requests data of the coupon screen 60 to the advertisement server 10 (S105). In this case, the user ID of the user and the coupon ID of an electronic coupon that corresponds to the coupon button 52 selected by the user (namely, the registration target electronic coupon) are transmitted to the advertisement server 10.

When the advertisement server 10 receives the above request, the control unit 11 of the advertisement server 10 obtains coupon information (S106). Specifically, the control unit 11 accesses the electronic coupon table and obtains a record in which the coupon ID received from the user terminal 20 is stored in the “coupon ID” field. Then, based on information stored in each field of the obtained record, the control unit 11 generates data of the coupon screen 60. Note that at this moment, the control unit 11 generates the code image 64 obtained by making a combination of a user ID, a coupon ID, and a registrant user ID into a code.

The control unit 11 transmits the data of the coupon screen 60 to the user terminal 20 (S107). Further, based on this data, the control unit 21 of the user terminal 20 displays the coupon screen 60 on the display unit 26 (S108).

The control unit 21 monitors whether or not the registration button 66 is selected while the coupon screen 60 is displayed on the display unit 26. In the case where the registration button 66 is selected, the control unit 21 requests data of the section designating screen 70 to the advertisement server 10 as illustrated in FIG. 21 (S109). In this case, the user ID of the user and the coupon ID of the registration target electronic coupon are transmitted to the advertisement server 10.

When the advertisement server 10 receives the above request, the control unit 11 (the candidate region setting unit 113) of the advertisement server 10 sets the candidate region 76 (S110). First, the control unit 11 (the first position information obtaining unit 112) accesses the user position table to read the position information of the user. Further, the control unit 11 also accesses the section table to identify the section 80 that includes a position indicated by the read position information. Moreover, the control unit 11 identifies eight sections 80 that surround this section 80. The control unit 11 then sets an aggregation of these nine sections 80 as the candidate region 76.

Note that the control unit 11 accesses the registration status table to determine whether or not the nine sections 80 include the section 80 to which the same electronic coupon as the registration target electronic coupon has been registered. In the case where such a section 80 is included, the control unit 11 excludes that section 80 from the candidate region 76.

Thereafter, the control unit 11 generates data of the section designating screen 70 and transmits the generated data to the user terminal 20 (S111). Further, based on this data, the control unit 21 of the user terminal 20 displays the section designating screen 70 on the display unit 26 (S112). By having the section designating screen 70 displayed, the candidate region 76 set in Step S110 is presented to the user.

The control unit 21 monitors whether or not any one of the sections 80 inside the candidate region 76 has been designated while the section designating screen 70 is displayed on the display unit 26. In the case where one of the sections 80 is designated, the control unit 21 notifies the section 80 designated by the user to the advertisement server 10 (S113). In this case, the user ID of the user, the coupon ID of the registration target electronic coupon, and the section ID of the section 80 designated by the user are transmitted to the advertisement server 10.

When the advertisement server 10 receives the above notification, the control unit 11 (the target region setting unit 114 and the association information registering unit 115) of the advertisement server 10 makes the section 80 designated by the user to be the section 80 that is the registration target, and registers the association between the registration target electronic coupon and the section 80 that is the registration target (S114).

Specifically, the control unit 11 adds a new record to the registration status table. Then, the control unit 11 newly generates a registered coupon ID and registers that registered coupon ID in the “registered coupon ID” field of the above new record.

Further, the control unit 11 registers the coupon ID received from the user terminal 20 in the “coupon ID” field of the above new record. The control unit 11 then registers the section ID received from the user terminal 20 in the “section ID” field of the above new record. The control unit 11 registers the user ID received from the user terminal 20 in the “registrant user ID” field of the above new record.

Moreover, the control unit 11 registers the current date/time in the “registration date/time” field of the above new record, and registers another date/time which is after an elapse of a given length of time from the current date/time in the “expiration date” field of the above new record. Also, the control unit 11 registers the value “0” in the “invalidity” field of the above new record.

When the processing of Step S114 is completed, the control unit 11 transmits data of a completion screen that indicates normal completion of the associating process to the user terminal 20 (S115). The completion screen is then displayed on the display unit 26 of the user terminal 20 (S116). In the above way, the processing executed when the menu button 42A of the menu screen 40 is selected is completed.

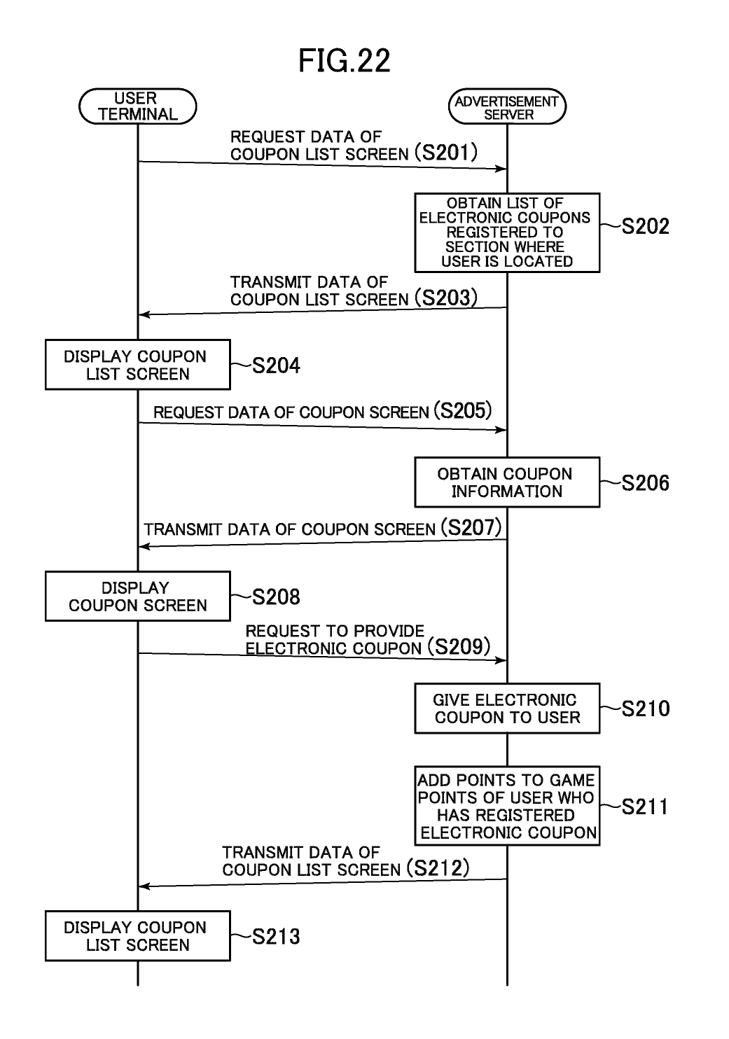

FIG. 22 is a diagram for illustrating an example of processing that is executed when the menu button 42B of the menu screen 40 is selected. The control unit 11 of the advertisement server 10 executes the processing of FIG. 22 according to a program, to thereby function as the second position information obtaining unit 116 and the electronic advertisement providing unit 117.

When the menu button 42B of the menu screen 40 is selected, the control unit 21 of the user terminal 20 requests data of the coupon list screen 90 to the advertisement server 10 (S201). In this case, the user ID of the user is transmitted to the advertisement server 10.

When the advertisement server 10 receives the above request, the control unit 11 of the advertisement server 10 obtains a list of electronic coupons that are registered to the section 80 where the user is located (S202). In other words, the control unit 11 obtains a list of electronic coupons that are available to the user.

First, the control unit 11 (the second position information obtaining unit 116) accesses the user position table to read the position information of the user. The control unit 11 also accesses the section table to obtain the section ID of the section 80 that includes a position indicated by the read position information. Further, the control unit 11 accesses the registration status table and obtains a record in which the obtained section ID is registered in the “section ID” field and the value “0” is registered in the “invalidity” field, to thereby obtain a list of electronic coupons that are registered to the section 80 where the user is located.

Then, the control unit 11 generates data of the coupon list screen 90 based on the result obtained in Step S202, and transmits the generated data to the user terminal 20 (S203). Based on this data, the control unit 21 of the user terminal 20 displays the coupon list screen 90 on the display unit 26 (S204).

The control unit 21 monitors whether or not any one of the coupon buttons 92 has been selected while the coupon list screen 90 is displayed on the display unit 26. In the case where one of the coupon buttons 92 is selected, the control unit 21 requests data of the coupon screen 100 to the advertisement server 10 (S205). In this case, the user ID of the user who is using the user terminal 20 and the coupon ID of an electronic coupon that corresponds to the coupon button 92 selected by the user (namely, the obtaining target electronic coupon) are transmitted to the advertisement server 10.

When the advertisement server 10 receives the above request, the control unit 11 of the advertisement server 10 obtains coupon information (S206). Specifically, the control unit 11 accesses the electronic coupon table and obtains a record in which the coupon ID received from the user terminal 20 is stored in the “coupon ID” field. Then, based on information stored in each field of the obtained record, the control unit 11 generates data of the coupon screen 100. Note that at this moment, the control unit 11 generates the code image 104 obtained by making a combination of a user ID, a coupon ID, and a registrant user ID into a code.

The control unit 11 transmits the data of the coupon screen 100 to the user terminal 20 (S207). Based on this data, the control unit 21 of the user terminal 20 displays the coupon screen 100 on the display unit 26 (S208).

The control unit 21 monitors whether or not the obtaining button 106 has been selected while the coupon screen 100 is displayed on the display unit 26. In the case where the obtaining button 106 is selected, the control unit 21 requests the advertisement server 10 to provide the electronic coupon (S209). In this case, the user ID of the user and the registered coupon ID of the obtaining target electronic coupon are transmitted to the advertisement server 10.

When the advertisement server 10 receives the above request, the control unit 11 (the electronic advertisement providing unit 117) of the advertisement server 10 gives the electronic coupon to the user (S210).

First, the control unit 11 accesses the registration status table to obtain a coupon ID and a registrant user ID that are associated with the registered coupon ID received from the user terminal 20. Specifically, the control unit 11 reads a record in which the registered coupon ID is stored in the “registered coupon ID” field and obtains a coupon ID and a registrant user ID that are stored in the “coupon ID” field and the “registrant user ID” field of the record.

Moreover, the control unit 11 adds a new record to the possession status table. Then, the control unit 11 registers the user ID received from the user terminal 20 in the “user ID” field of the above new record. The control unit 11 also registers the coupon ID and the registrant user ID obtained from the registration status table in the “coupon ID” field and the “registrant user ID” field of the above new record.

Thereafter, the control unit 11 adds points to the game points of the user who has registered the electronic coupon given in Step S210 to the user (S211). Specifically, the control unit 11 accesses a record in which the registrant user ID obtained in Step S210 from the registration status table is stored in the “user ID” field, out of the records of the user table, and adds a given value to the value of the “game point” field in this record.

After executing Step S211, the control unit 11 generates data of the coupon list screen 50 and transmits the generated data to the user terminal 20 (S212). Then, the user terminal 20 displays the coupon list screen 50 on the display unit 26 based on this data (S213). In the above way, the processing that is executed when the menu button 42B of the menu screen 40 is selected is completed.

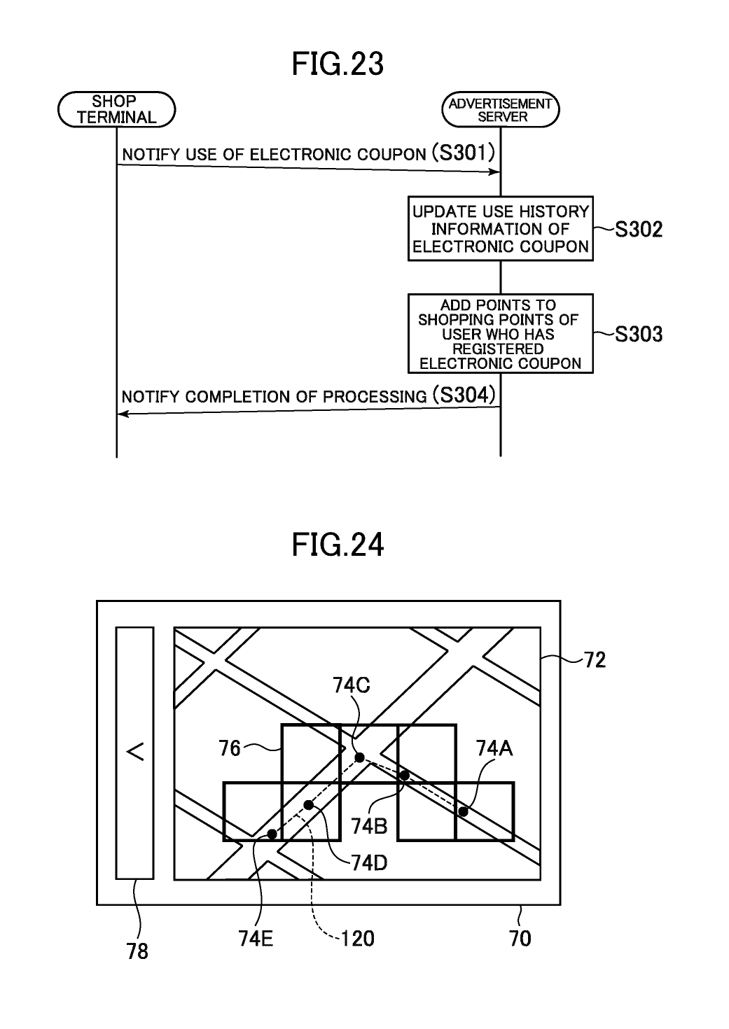

FIG. 23 is a diagram for illustrating an example of processing that is executed when an electronic coupon is used at a shop. In other words, it illustrates an example of processing that is executed when the code image 64 displayed on the display unit 26 of the user terminal 20 is read by the shop terminal 30.

As illustrated in FIG. 23, when an electronic coupon is used at a shop, the shop terminal 30 notifies the advertisement server 10 of the fact that the electronic coupon has been used (S301). In this case, the shop terminal 30 reads a user ID, a coupon ID, and a registrant user ID from the code image 64, and transmits the user ID, the coupon ID, and the registrant user ID to the advertisement server 10.

When the advertisement server 10 receives the above notification, the control unit 11 of the advertisement server 10 updates the use history information of the electronic coupon (S302). Specifically, the control unit 11 accesses a record in which the user ID and the coupon ID received from the user terminal 20 are stored in the “user ID” field and the “coupon ID” field, out of the records of the possession status table, and updates the “use history information” field of the record.

Further, the control unit 11 adds points to the shopping points of the user who has registered the used coupon (S303). Specifically, the control unit 11 accesses a record in which the registrant user ID received from the user terminal 20 is stored in the “user ID” field, out of the records of the user table, and adds a given value to the value of the “shopping point” field of the record.

After executing Step S303, the control unit 11 notifies the completion of the processing to the shop terminal 30 (S304). In the above way, the processing that is executed when an electronic coupon is used at a shop is completed.

According to the advertisement system 1 according to the first embodiment described above, a place where an electronic coupon can be registered is set based on the position of the user. Therefore, to register an electronic coupon, a user needs to actually visit the place to which he wants to register the electronic coupon or the vicinity of that place. Indiscriminate registration of a huge number of electronic advertisements can be prevented as a result. Further, Registering an electronic coupon to a place unsuitable as the setting where electronic coupons are provided can be prevented as well.

Moreover, according to the advertisement system 1, not only the section 80 that includes the user's position, but also the sections 80 in the vicinity of that section 80 is set as a place to which an electronic coupon can be registered. As a result thereof, the convenience of users can be guaranteed. In the case where a user wishes to register an electronic coupon to a place across a large intersection, for example, the user is allowed to register the electronic coupon without actually crossing over to the other side of the intersection. Also, it becomes possible to guarantee that at least one section 80 in which a road runs is set as a place to which an electronic coupon can be registered. In other words, it becomes possible to guarantee that at least one place where there is traffic of men is set as a place to which an electronic coupon can be registered.

Further, according to the advertisement system 1, it is configured that an electronic coupon is associated with a region (a section 80) instead of a position, and as a result thereof, it becomes possible to simplify processing for preventing a registration of plurality of identical electronic coupons to places close to one another.

Moreover, the advertisement system 1 awards game points to a user when an electronic coupon registered by that user is obtained by another user. The advertisement system 1 also awards shopping points to a user when an electronic coupon registered by that user is obtained and used by another user. According to the advertisement system 1, it becomes possible to give to users a fun to compete for an amount of game points. It also becomes possible to promote active and efficient electronic advertising.

### Second Embodiment

A second embodiment of the present invention is described. An advertisement system according to the second embodiment of the present invention has an overall configuration that is the same as that of the first embodiment (FIG. 1). The advertisement system 1 according to the second embodiment provides services similar to those in the first embodiment.

However, the second embodiment differs from the first embodiment in how the candidate region 76 is set. The following is a description of this difference.

FIG. 24 is a diagram for illustrating an example of the section designating screen 70 in the second embodiment. In the second embodiment, a plurality of sections 80 through which the user has passed are set as the candidate region 76. For example, a plurality of section 80, through which a line 120 connecting the most recent user positions, 74A, 74B, 74C, 74D, and 74E in order runs, are set as the candidate region 76. The user designates one of the plurality of sections 80 included in the candidate region 76 as a registration target region on the section designating screen 70 as in the first embodiment.

The sections 80 through which the user has passed are the sections 80 where a man has passed through. Setting the candidate region 76 in the manner described above therefore enables to present to users the sections 80 that are passable for a man as regions to which an electronic coupon can be registered.

Note that as in the first embodiment, in the second embodiment also, the section 80 to which an electronic coupon that has a given relationship with the registration target electronic coupon is already registered may be excluded from the candidate region 76. For example, the section 80 to which the same electronic coupon as the registration target electronic coupon is already registered may be excluded from the candidate region 76.

Function blocks that are implemented in the advertisement system 1 according to the second embodiment are basically the same as those in the first embodiment (FIG. 12). However, the storage unit 110, the first position information obtaining unit 112, and the candidate region setting unit 113 operate differently from those in the first embodiment, and the operation of these function blocks is therefore described here.

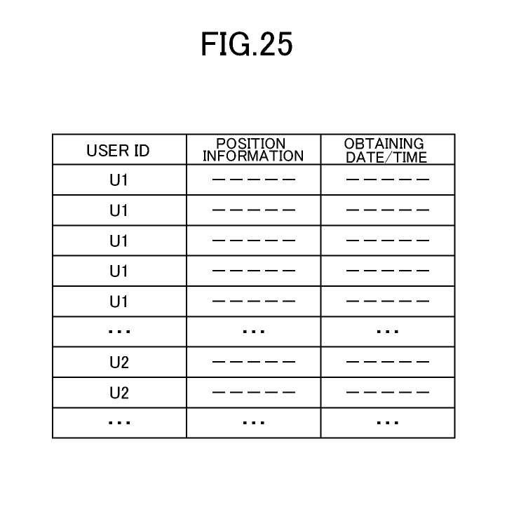

The storage unit 110 in the second embodiment stores the history of position information of the user (the user terminal 20). FIG. 25 is an example of a user position table in the second embodiment. Unlike the user position table of FIG. 14, the user position table of FIG. 25 stores N (N: an integer equal to or larger than 2) most recent pieces of position information for each user. In this case, the first position information obtaining unit 112 obtains the user position information history from the storage unit 110.

Note that instead of the user position table of FIG. 25, the history of the sections 80 through which the user has passed may be stored in the storage unit 110.

Alternatively, the user terminal 20 may store a position information history to transmit the position information history to the advertisement server 10 when, for example, the registration button 66 of the coupon screen 60 is selected. Further, the position information history transmitted from the user terminal 20 may be obtained by the first position information obtaining unit 112. In the case where the position information history is transmitted from the user terminal 20 to the advertisement server 10, the user's agreement may be sought regarding the privacy.

The candidate region setting unit 113 sets the candidate region 76 based on the position information history of the user. For example, the candidate region setting unit 113 identifies the sections 80 through which the user has passed based on the position information history of the user.

Specifically, the candidate region setting unit 113 identifies the sections 80 through which the user has passed within the most recent given period. The “most recent given period” used here is, for example, a period between the current time and a point in time that precedes the current time by a given length of time. To give another example, the “most recent given period” may be a period between a point in time at which the latest piece of position information has been obtained and a point in time at which the piece of position information that precedes the latest piece of position information by M (M: an integer equal to or larger than 1) has been obtained.

For example, as illustrated in FIG. 24, the candidate region setting unit 113 sets, as the candidate region 76, a plurality of sections 80 through which the line 120, connecting the user positions 74A to 74E within the most recent given period in order, runs.

According to the advertisement system 1 according to the second embodiment described above, regions that are passable for a man can be presented to users as regions to which an electronic coupon can be registered.

### Third Embodiment

A third embodiment of the present invention is described. An advertisement system according to the third embodiment of the present invention has an overall configuration that is the same as that of the first embodiment (FIG. 1). The advertisement system 1 according to the third embodiment provides services similar to those in the first embodiment.

However, the third embodiment differs from the first embodiment in how the candidate region 76 is set and how a registration target region is designated. Specifically, the third embodiment differs from the first embodiment in that no sections 80 are set on the map. The following is a description of this difference.

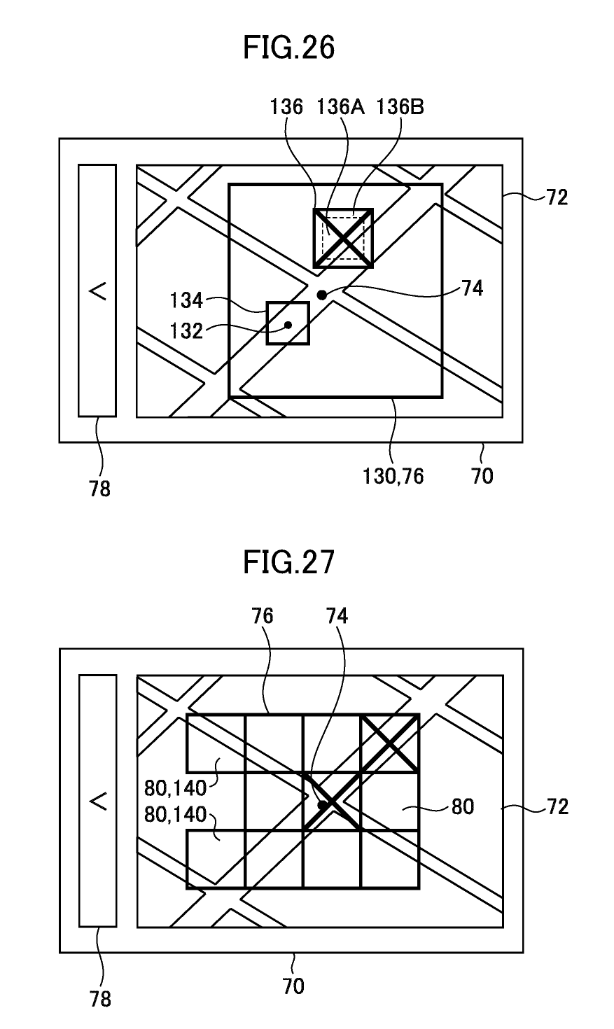

FIG. 26 is a diagram for illustrating an example of the section designating screen 70 in the third embodiment. In the third embodiment, a given rectangular region 130 centered around the user position 74 is set as the candidate region 76. This candidate region 76 is displayed on the map 72.

In this case, the user designates a registration target region by pointing to a position inside the candidate region 76. For example, a given rectangular region 134 centered around a user-designated position 132 is set as the registration target region as illustrated in FIG. 26. The rectangular region 134 in this case is naturally a rectangular region smaller in size than the candidate region 76. Note that the user may designate a registration target region by drawing a trace so as to designate a region (a rectangle or a circle, for example) inside the candidate region 76.

Note that as in the first embodiment, in the third embodiment also, a region to which an electronic coupon that has a given relationship with the registration target electronic coupon is already registered may be excluded from the candidate region 76. For example, a region with which the same electronic coupon as the registration target electronic coupon is already associated may be excluded from the candidate region 76.

Exclusion regions to be excluded from the candidate region 76 are denoted by a reference symbol “136” in FIG. 26. The exclusion regions 136 include a region 136A to which the same electronic coupon as the registration target electronic coupon is already registered and a vicinity region 136B of that region 136A. Note that the vicinity region 136B is set in order to guarantee that the above rectangular region 134 centered around the user-designated position 132 does not overlap with the above region 136A.

Function blocks that are implemented in the advertisement system 1 according to the third embodiment are basically the same as those in the first embodiment (FIG. 12). However, the candidate region setting unit 113 and the target region setting unit 114 operate differently from those in the first embodiment, and the operation of these function blocks is therefore described here.

The candidate region setting unit 113 sets the user's position and the vicinity regions thereof as the candidate region 76. For example, the candidate region setting unit 113 sets a rectangular region centered around the user's position as the candidate region 76. Note that the shape of the candidate region 76 is not limited to be a rectangle and can be shapes other than a rectangular shape. For instance, the candidate region setting unit 113 may set a circular region that is within a reference distance from the user's position as the candidate region 76.

The target region setting unit 114 receives the designation of a position or a partial region inside the candidate region 76 from the user. The target region setting unit 114 then sets a registration target region based on the position or the partial region designated by the user.

When a position inside the candidate region 76 is designated by the user, the target region setting unit 114 sets a region that includes the designated position as a registration target region. For example, the target region setting unit 114 sets the rectangular region 134 centered around the user-designated position 132 as a registration target region. Alternatively, the target region setting unit 114 may instead set a circular region that is within a reference distance from the user-designated position 132 as a registration target region.

When a partial region inside the candidate region 76 is designated by the user, on the other hand, the target region setting unit 114 sets the designated partial region as a registration target region.

Note that the present invention is not limited to the first embodiment, the second embodiment, and the third embodiment described above.

[1] As described, it is configured that when a region to which an electronic advertisement having a given relationship with the registration target electronic advertisement is already registered is included in the candidate region, the candidate region setting unit 113 excludes that region from the candidate region. When such a region is excluded from the candidate region, the candidate region setting unit 113 may set a substitute region for the region to be excluded from the candidate region, based on the first position information obtained by the first position information obtaining unit 112, to add that substitute region to the candidate region.

FIG. 27 is an example of how the section designating screen 70 looks in the case where a substitute region is added to the candidate region. In the example of FIG. 27, two sections 80 are excluded from the candidate region 76 as in the example of FIG. 9. Specifically, the central section 80 and the upper right section 80 are excluded from the candidate region 76. However, in place of the excluded sections 80, two sections 80 are set as substitute regions 140 from among the sections 80 that are outside the initial candidate region 76 (FIG. 8), and are added to the candidate region 76.

In other words, two sections 80 adjacent to the initial candidate region 76 are added as the substitute regions 140 to the candidate region 76. Specifically, the section 80 to the immediate left of the upper left section 80 of the initial candidate region 76 and the section 80 to the immediate left of the lower left section 80 of the initial candidate region 76 are added to the candidate region 76 as the substitute regions 140. The user can consequently select a registration target region out of nine sections 80. In other words, with the above configuration, it becomes possible to guarantee that the user can always designate a registration target region out of nine sections 80.

As described above, the candidate region setting unit 113 sets at least one of the sections 80 outside the initial candidate region 76 as the substitute region 140. Examples of how the substitute region 140 is set are described below.

[1-1] The candidate region setting unit 113 selects the substitute region 140 out of, for example, the sections 80 adjacent to the initial candidate region 76. Specifically, the candidate region setting unit 113 selects at random at least one of the sections 80 adjacent to the initial candidate region 76 as the substitute region 140. Also, the candidate region setting unit 113 may preferentially select the section 80 adjacent to the section 80 that is excluded from the candidate region 76 as the substitute region 140.

[1-2] To give another example, the candidate region setting unit 113 selects the substitute region 140 out of the sections 80 through which the user has passed.

In this case, the storage unit 110 stores the history of position information of the user as in the second embodiment. In other words, a user position table as the one in FIG. 25 is stored in the storage unit 110.

Based on the above user position table, the candidate region setting unit 113 identifies the sections 80 through which the user has passed. For example, the candidate region setting unit 113 identifies the sections 80 through which the user has passed in the most recent given period. The candidate region setting unit 113 then selects the substitute region 140 out of the identified sections 80.

The “most recent given period” used here is, for example, a period between the current time and a point in time that precedes the current time by a given length of time. Alternatively, the “most recent given period” may be, for example, a period between a point in time at which the latest piece of position information has been obtained and a point in time at which the piece of position information that precedes the latest piece of position information by M (M: an integer equal to or larger than 1) has been obtained.

Note that as in the second embodiment, the storage unit 110 may store the history of the sections 80 through which the user has passed instead of the user position table of FIG. 25.

Alternatively, the user terminal 20 may store a position information history to transmit the position information history to the advertisement server 10 when, for example, the registration button 66 of the coupon screen 60 is selected.

The sections 80 through which the user has passed are the sections 80 where a man has passed through. Therefore, with the above configuration, the section 80 that is passable for a man is added as the substitute region 140 to the candidate region 76 even when the section 80 to which the same electronic coupon as the registration target electronic coupon is already registered is excluded from the candidate region 76. In short, this allows the user to designate the section 80 that is passable for a man as a registration target region.

[1-3] Instill another example, the candidate region setting unit 113 selects the substitute region 140 out of the sections 80 that include a particular road. Specifically, the candidate region setting unit 113 selects, as the substitute region 140, the section 80 the distance of which from the initial candidate region 76 (or a position indicated by the first position information) is less than a reference distance and which includes a particular road.

A “particular road” used here is a major road, and is, for example, a road where traffic of men is heavy. Further, the “distance from the initial candidate region 76” may be the distance from the center of the initial candidate region 76, or may be the distance from the border of the initial candidate region 76.

In this case, information indicating whether or not a particular road is included is stored for each section 80. For example, a “particular road” field is added to the section table to store information indicating whether or not the section 80 includes a particular road in the “particular road” field. Further, the candidate region setting unit 113 determines whether or not the section 80 includes a particular road based on this section table, and sets the substitute region 140 based on the result of the determination. Note that the candidate region setting unit 113 may refer to road map information to determine whether or not the section 80 includes a particular road.

By configuring as above, the section 80 that has heavy traffic of men is added as the substitute region 140 to the candidate region 76 even when the section 80 to which the same electronic coupon as the registration target electronic coupon is already registered is excluded from the candidate region 76. In short, this allows the user to designate the section 80 that has heavy traffic of men as a registration target region.

[1-4] In yet still another example, the candidate region setting unit 113 selects the substitute region 140 out of the sections 80 that include a particular facility. Specifically, the candidate region setting unit 113 selects, as the substitute region 140, the section 80 the distance of which from a position indicated by the first position information (or the initial candidate region 76) is less than a reference distance and which includes a particular facility.

A “particular facility” used here is a facility where people tend to gather, and is, for example, a convenience store or the like.

Information indicating whether or not a particular facility is included is stored for each section 80 in this case. For example, a “particular facility” field is added to the section table to store information indicating whether or not the section 80 includes a particular facility in the “particular facility” field. The candidate region setting unit 113 determines whether or not the section 80 includes a particular facility based on this section table, and sets the substitute region 140 based on the result of this determination. Note that the candidate region setting unit 113 may refer to road map information to determine whether or not the section 80 includes a particular facility.

By configuring as above, the section 80 where people tend to gather is added as the substitute region 140 to the candidate region 76 even when the section 80 to which the same electronic coupon as the registration target electronic coupon is already registered is excluded from the candidate region 76. In short, this allows the user to designate the section 80 where people tend to gather as a registration target region.

[1-5] In yet still another example, the candidate region setting unit 113 sets the substitute region 140 based on the volume of traffic of men.

Information indicating the volume of traffic of men is stored for each section 80 in this case. For example, a “traffic volume” field is added to the section table to store information about the traffic volume of the section 80 in the “traffic volume” field. Then, the candidate region setting unit 113 selects the substitute region 140 based on the section table.

The candidate region setting unit 113 selects the substitute region 140 based on the traffic volume of each section 80 out of the sections 80 the distance of which from the initial candidate region 76 (or a position indicated by the first position information) is less than a reference distance. For example, the candidate region setting unit 113 selects the sections 80 as the substitute region 140 in descending order of traffic volume. To give another example, the candidate region setting unit 113 may select the section 80 where the traffic volume is equal to or more than a reference volume as the substitute region 140.

By configuring as above, the section 80 that has heavy traffic of men is added as the substitute region 140 to the candidate region 76 even when the section 80 to which the same electronic coupon as the registration target electronic coupon is already registered is excluded from the candidate region 76. In short, this allows the user to designate the section 80 that has heavy traffic of men as a registration target region.

While the description given above deals mainly with cases where a configuration for setting the substitute region 140 is implemented in the first embodiment, a configuration for setting the substitute region 140 can be implemented in the second embodiment and the third embodiment as well.

[2] For instance, the candidate region setting unit 113 may set the candidate region in a region that is within a reference distance from the location of a shop of the issuer of an electronic coupon (an advertiser), based on the first position information.

In the example of FIG. 8, for instance, the candidate region setting unit 113 may set only the sections 80 that are within the reference distance from the location of the above shop as the candidate region 76, out of the nine sections 80 that are set based on the first position information.

In the example of FIG. 24, for instance, the candidate region setting unit 113 may sets only the sections 80 that are within the reference distance from the location of the above shop as the candidate region 76, out of the plurality of sections 80 through which the user has passed.

In the example of FIG. 26, for instance, the candidate region setting unit 113 may set, as the candidate region 76, only the regions that are within the reference distance from the location of the above shop, out of the rectangular region 130 that is set based on the first position information.

[3] For example, the target region setting unit 114 may automatically set a partial region inside the candidate region 76 as a registration target region without receiving the user's designation.

[4] For example, the coupon list screen 90 displayed in the case of obtaining an electronic coupon may be configured to display not only an electronic coupon registered to the section 80 that includes the position of the user but also electronic coupons registered to the sections 80 in the vicinity of this section 80.

In this case, the order in which electronic coupons are displayed may be set based on the distance between the section 80 to which an electronic coupon is registered and the position of the user. For example, the display order may be set so that an electronic coupon registered to the section 80 that is at a shorter distance from the user's position is placed higher in the display order. In other words, the place in display order of an electronic coupon registered to the section 80 that is at a short distance from the user's position may be set higher than the place in display order of an electronic coupon registered to the section 80 that is at a long distance from the user's position.

Alternatively, the display order of electronic coupons may be set based on the evaluation values of the electronic coupons. In this case, the evaluation value of an electronic coupon is calculated based on the distance between the section 80 to which the electronic coupon is registered and the position of the user, and on the popularity of the electronic coupon. For example, the evaluation value is calculated so that a higher evaluation value is given when the above distance is shorter. The evaluation value is also calculated so that a higher evaluation value is given when the popularity is higher. Note that the popularity of an electronic coupon is set based on at least one of the number of times the electronic coupon is actually used and the number of users who have obtained the electronic coupon.

Further, the coupon list screen 90 displayed in the case of obtaining an electronic coupon may display only electronic coupons that belong to a category specified by the user.

[5] In the case where a request to register an electronic coupon has been made by a user, for example, the control unit 11 may determine whether or not the moving speed of the user is larger than a reference speed based on the history of position information of the user. The control unit 11 may estimate the traveling speed of the user based on, for example, the position of the user at a first point in time and the position of the user at a second point in time, which is later than the first point in time. When the user's moving speed is larger than the reference speed, the control unit 11 may deny the registration request from that user.

[5] In the case where a section 80 is relatively large (e.g., about 500 m to 3 km along one side), for example, the candidate region setting unit 113 may be configured not to present all of eight sections 80 surrounding the section 80 of interest as the candidate region 76.

For example, the candidate region setting unit 113 may select at least one of eight sections 80 surrounding the section 80 that includes a position indicated by past position information of the user (namely, a past position of the user) as the sections 80 to be included in the candidate region 76 (namely, the sections 80 to be presented as the candidate region 76), based on a past position of the user. In other words, the candidate region setting unit 113 may select at least one of the above eight sections 80 as the sections 80 to be included in the candidate region 76, based on where in the sections 80 the user's past position is located.

In the case where the user's past position is located near the center of the section 80, for example, the candidate region setting unit 113 may present, as the candidate region 76, to the user two sections 80, namely, the section 80 that includes the user's past position and, the section 80 closest to the user's above past position from among the eight sections 80 surrounding that section 80.

In the case where the user's past position is located near a corner of the section 80, for another example, the candidate region setting unit 113 may present to the user four sections 80, namely, the section 80 that includes the user's past position and three sections 80 adjacent to the above corner as the candidate region 76.

[7] For example, the sections 80 may be configured not have a uniform size. For example, the size of the sections 80 included in an area may be varied depending on the population density of the area. Specifically, the size of a section 80 may be set relatively small in an area that is high in population density such as an inner city area may be set to a relatively small size, whereas the size of a section 80 may be set relatively large in an area that is low in population density such as a local area.

When the population density is high, for example, there is a high probability that a plurality of users attempt to register the same electronic coupon to one section 80. Regarding this, the probability that a plurality of users attempt to register the same electronic coupon to one section 80 can be reduced by setting the size of a section 80 relatively small in an area that is high in population density.

In the case where the size of the sections 80 is varied in the manner described above, the interval at which position information is transmitted from the user terminal 20 to the advertisement server 10 may be controlled depending on the size of a section 80. Specifically, the transmission interval of the position information may be set longer as the size of a single section 80 becomes larger, and the transmission interval of the position information may be set shorter as the size of a section 80 becomes smaller.

When controlling the transmission interval of the position information depending on the size of a section 80, association relation information that indicates an association relation between the transmission interval of the position information and the size of a section 80 becomes necessary. This association relation information is set so that, as described above, the transmission interval of the position information is set longer as the size of a section 80 becomes larger, and the transmission interval of the position information is set shorter as the size of a single section 80 becomes smaller.

For example, the above association relation information is stored in, the storage unit 12 or the database 15, and the control unit 11 of the advertisement server 10 determines the above transmission interval in the user terminal 20 based on the above association relation information and the position information of the user terminal 20. In this case, the control unit 11 of the advertisement server 10 notifies the determined transmission interval to the user terminal 20. The user terminal 20 executes position information transmission to the advertisement server 10 at the notified transmission interval.

Alternatively, the control unit 21 of the user terminal 20 may determine the above transmission interval in the user terminal 20 based on the above association relation information and the position information of the user terminal 20. Note that in this case, it may be configured that the association relation information is be stored in the storage unit 22, or that the association relation information stored in the storage unit 12 or the database 15 is supplied to the user terminal 20 via the communication network 2.

The frequency at which the section 80 that the user is currently located changes becomes low when the size of a section 80 is large. When the frequency at which the section 80 that the user is currently located changes is low, the necessity to transmit the position information of the user terminal 20 to the advertisement server 10 at a high frequently becomes low. Regarding this point, it is possible to prevent unnecessary transmission of position information in the above way.

[8] For example, the candidate region 76 and the registration target region can have shapes other than rectangular shapes. Similarly, a plurality of regions having shapes other than rectangular shapes may be set on the map in place of the sections 80 in the first embodiment and the second embodiment. However, note that keeping these regions as a rectangular shape can simplify processing.

[9] In the case where the user terminal 20 is provided with a sensor configured to detect the motion of the user terminal 20 (e.g., an acceleration sensor or a gyro sensor), for example, the operation of shaking the user terminal 20 may be employed as the operation of registering or obtaining an electronic coupon. For example, it may be configured that when the user shakes the user terminal 20 while designating any of the sections 80 on the section designating screen 70, an electronic coupon may be associated with the designated section 80. Similarly, an electronic coupon may be provided to the user on the coupon screen 100 when the user shakes the user terminal 20. Such a configuration causes users to shake their user terminals 20 on the street, which is expected to draw the attention of other people. An increase of the interest in services provided by the advertisement server 10 can be expected as a result.

[10] For example, the shop terminal 30 may display a screen for checking the registration status of an electronic coupon that is provided by the advertiser. In this case, it is only necessary to display this screen when the shop terminal 30 accesses the advertisement server 10.

[11] The advertisement system 1 may include a plurality of advertisement servers 10, for example. Processing (functions) may be divided among the plurality of advertisement servers 10 in this case. For instance, it may be configured that one advertisement server 10 executes processing that is related to the registration of an electronic coupon while another advertisement server 10 executes processing that is related to the providing of an electronic coupon. Specifically, it may be configured that the first position information obtaining unit 112, the candidate region setting unit 113, the target region setting unit 114, and the association information registering unit 115 are implemented by one advertisement server 10, while the second position information obtaining unit 116 and the electronic advertisement providing unit 117 are implemented by another advertisement server 10.

[12] For example, all or some of the function blocks illustrated in FIG. 12 may be implemented by the user terminal 20. The user terminal 20 may implement, for example, function blocks other than the storage unit 110. In other words, the user terminal 20 (an advertisement processing device) may be designed so as to include function blocks other than the storage unit 110. The user terminal 20 (an advertisement processing device) may also be designed so as to include the first position information obtaining unit 112, the candidate region setting unit 113, the target region setting unit 114, and the association information registering unit 115. The user terminal 20 (an advertisement processing device) may also be designed so as to include the second position information obtaining unit 116 and the electronic advertisement providing unit 117.

[13] While the description given above deals mainly with cases of providing electronic coupons, the present invention can be applied to cases where electronic advertisements other than electronic coupons are provided as well. For instance, the present invention is also applicable to cases of providing electronic fliers. The present invention is also applicable to cases of providing image data (types of image data other than electronic coupons or electronic fliers) as an electronic advertisement. The present invention is further applicable to cases of providing audio data or animation data as an electronic advertisement.

### REFERENCE SIGNS LIST

1 advertisement system, 2 communication network, 10 advertisement server, 11, 21 control unit, 12, 22 storage unit, 13, 23 communication unit, 14 optical disc drive unit, 15 database, 20 user terminal, 24 GPS reception unit, 25 operation unit, 26 display unit, 27 audio output unit, 30 shop terminal, 40 menu screen, 42A, 42B, 42C menu button, 44 game point field, 46 shopping point field, 50, 90 coupon list screen, 52,92 coupon button, 54, 68, 78, 94, 108 back button, 60, 100 coupon screen, 62, 102 coupon, 64, 104 code image, 66 registration button, 70 section designating screen, 72 map, 74 user position, 76 candidate region, 80 section, 106 obtaining button, 110 storage unit, 111 association information storage unit, 112 first position information obtaining unit, 113 candidate region setting unit, 114 target region setting unit, 115 association information registering unit, 116 second position information obtaining unit, 117 electronic advertisement providing unit, 130, 134 rectangular region, 132 user-designated position, 136 exclusion region, 140 substitute region, U1, U2 user, C electronic coupon, A region.

The invention claimed is:

1: An advertisement system, comprising:
at least one processor; and
at least one memory device that stores a plurality of instructions, which when executed by the at least one processor, cause the at least one processor to:
obtain position information that indicates a position of a user terminal and that is obtained by the user terminal;
set a candidate region based on the position information, the candidate region being a candidate for a target region in real space to be associated with an electronic advertisement;
set a partial region of the candidate region as the target region to be associated with the electronic advertisement; and
register association information in a storage, the association information indicating an association between the electronic advertisement and a region set as the target region.

2: The advertisement system according to claim 1,
wherein the plurality of instructions cause the at least one processor to:
set a region that comprises a plurality of partial regions, as the candidate region, based on the position information, and
set at least one of the plurality of partial regions as the target region to be associated with the electronic advertisement.

3: The advertisement system according to claim 2,
wherein the plurality of instructions cause the at least one processor to:
display the plurality of partial regions on the user terminal;
receive a designation of at least one of the plurality of partial regions; and
set, as the target region to be associated with the electronic advertisement, at least one designated partial region.

4: The advertisement system according to claim 2,
wherein the plurality of partial regions include a first partial region including the position of the user terminal indicated by the position information and a plurality of second partial regions located around the first partial region.

5: The advertisement system according to claim 1,
wherein the plurality of instructions cause the at least one processor to:
display the candidate region on the user terminal;
receive a designation of a position or a partial region inside the candidate region; and
set the target region to be associated with the electronic advertisement, based on the designated position or the designated partial region.

6: The advertisement system according to claim 1,
wherein the plurality of instructions cause the at least one processor to:
set the candidate region based on the position information;
determine whether or not the candidate region includes a region to which another electronic advertisement having a given relationship with the electronic advertisement in question is already associated;
exclude the region from the candidate region, in a case where it is determined that the candidate region includes the region; and
set a region outside the candidate region as a substitute region for the region excluded from the candidate region, and add the substitute region to the candidate region.

7: The advertisement system according to claim 6,
wherein the plurality of instructions cause the at least one processor to set, as the substitute region, a region through which the user terminal has passed from among regions that are outside the candidate region.

8: The advertisement system according to claim 6,
wherein the plurality of instructions cause the at least one processor to set, as the substitute region, a region that includes a particular road from among regions that are outside the candidate region.

9: The advertisement system according to claim 6,
wherein the plurality of instructions cause the at least one processor to set, as the substitute region, a region that includes a particular facility from among regions that are outside the candidate region.

10: The advertisement system according to claim 6,
wherein the plurality of instructions cause the at least one processor to set, as the substitute region, a region outside the candidate region based on a volume of traffic of passerby.

11: The advertisement system according to claim 1,
wherein the plurality of instructions cause the at least one processor to set the candidate region based on the position information in a region that is within a reference distance from a location of a shop run by an advertiser of the electronic advertisement.

12: An advertisement system control method, comprising:
obtaining, by the advertisement system, position information that indicates a position of user terminal and that is obtained by the user terminal;
setting, by the advertisement system, a candidate region based on the position information, the candidate region being a candidate for a target region in real space to be associated with an electronic advertisement;
setting, by the advertisement system, a partial region of the candidate region as the target region to be associated with the electronic advertisement; and
registering, by the advertisement system, association information in a storage, the association information indicating an association between the electronic advertisement and the region set as the target region.

13-14. (canceled)

15: A non-transitory information recording medium having a program recorded thereon, the program for causing a computer to:
obtain position information that indicates a position of a user terminal and that is obtained by the user terminal;
set a candidate region based on the position information, the candidate region being a candidate for a target region in real space to be associated with an electronic advertisement;
set a partial region of the candidate region as the target region to be associated with the electronic advertisement; and
register association information in a storage, the association information indicating an association between the electronic advertisement and the region set as the target region.

16: The advertisement system according to claim 1,
wherein the plurality of instructions cause the at least one processor to:
obtain position information that indicates a position of another user terminal;
obtain an electronic advertisement to be provided to the other user terminal from among electronic advertisements registered in the storage, based on regions registered in the storage and the position information; and
display the obtained electronic advertisement on the other user terminal.
